(19) United States
(12) Patent Application Publication
(10) Pub. No.: US 2026/0202683 A1
(43) Pub. Date: Jul. 16, 2026

(54) METHODS FOR VISION CORRECTION

(71) Applicant: JOURNEY1 INC, South San Francisco, CA (US)

(72) Inventors: Yair ALSTER, Tel Aviv (IL); Omer RAFAELI, Rishpon (IL); Eugene DE JUAN, JR., SAN FRANCISCO, CA (US); Barak AZMON, Tel Aviv (IL); Matt CLARKE, SAN FRANCISCO, CA (US)

(73) Assignee: JOURNEY1 INC, South San Francisco, CA (US)

(21) Appl. No.: 19/133,732

(22) PCT Filed: Nov. 28, 2023
(86) PCT No.: PCT/US2023/081438

§ 371 Date: May 29, 2025

Related U.S. Application Data
(60) Provisional application No. 63/429,049, filed on Nov. 30, 2022.

(51) Int. Cl. G02C 7/04

(52) U.S. Cl. CPC G02C 7/049; G02C 7/047

(57) ABSTRACT

Disclosed herein are soft contact lenses to mask astigmatism and other optical aberrations. The soft contact lenses have a lens body with an anterior surface, a posterior surface, and at least one fenestration traversing through these surfaces. The fenestration(s) promote or facilitate flow of a tear fluid into a lenticular volume over a corneal surface of the eye and under the posterior surface of the lens body. The tear fluid in the lenticular volume forms a tear lens to mask the astigmatism or other optical aberrations. Further described herein are the placement, size, and geometries of the at least one fenestration to optimally promote or facilitate the tear fluid flow for forming the tear lens. The fenestration(s) can be configured to optimize tear fluid flow from adjacent a tear meniscus of the eye.

### CROSS REFERENCE

This application claims the benefit of U.S. Provisional Application No. 63/429,049, filed Nov. 30, 2022, the content of which is fully incorporated herein by reference.

### BACKGROUND

An astigmatism is a type of refractive error due to rotational asymmetry in the eye's refractive power. The underlying mechanism involves an irregular curvature of the cornea or abnormalities in the lens of the eye. People who have an astigmatic cornea may require a contact lens that will correct for different refractive errors in at least two meridians. Additionally, those people who have such refractive errors and who use contact lenses can have many different front surface optical powers. The optical power at each meridian, the angle between meridians, and/or the diameter across which the optical power difference occurs often differs from one individual to another. Current solutions for treatment of such corneal irregularities relies on a contact lens that has more than one base curve and with features to allow the lens to align and/or rotate to the particular astigmatism axis of the wearer, for example, by relying on structural elements such as a prism ballast, dynamic stabilization elements, and others. Such lenses are generally known as toric lenses. However, toric lenses typically require that multiple lenses be manufactured for each power difference and each angle between meridians. It is generally assumed that the opposite meridians have relatively similar curvatures and that a shift of +/−5 degrees is not usually very noticeable, so, with 10 degrees axis steps, hence 18 lenses are typically required for each sphere and cylindrical power combination to cover the range of astigmatisms a patient may have. There are therefore needs for solutions to reduce the number of different contact lenses needed to be manufactured and stored, as well as to improve the treatment options for patients with astigmatism or other optical aberrations in general.

### SUMMARY

A refractive error of the eye often results in poor vision, such as a blurred or distorted vision, as the eye is unable to focus the light onto the retina. Common refractive errors include, but are not limited to, myopia (nearsightedness), hyperopia (farsightedness), presbyopia, and astigmatism. Astigmatism is often caused by an irregularly shaped cornea, where the non-spherical or variable curvature of the cornea causes light rays to focus at different points on the retina. In some cases, refractive errors include higher order aberrations (e.g., third or higher) that are difficult to correct and that include, but are not limited to, corneal coma, trefoil aberration, and spherical aberration.

For those having a refractive error of the eye, contact lenses, including toric soft lenses and rigid gas permeable (RGP) contact lenses, may be used to correct the refractive error to help focus the light onto the retina. In some cases, to correct for corneal irregularities, specialized and/or individualized contact lenses having a number of different features may be needed. In some cases, the various features allow the lens to align and/or rotate to the particular astigmatism axis of a user, for example, by relying on structural elements such as a prism ballast, dynamic stabilization elements, among others. In some cases, to correct astigmatism a cylindrical lens (a segment cut from a cylinder) may be used, where the cylindric lens has no refractive power along one axis and are concave or convex along the other axis. Therefore, contact lenses that can correct a refractive error with one or fewer designs would be beneficial, since such contact lenses can reduce the number of different types of contact lenses needed to be manufactured and tried by a subject to find a fit.

Soft contact lenses designed to form a tear lens when worn on the eye have been developed to correct the refractive error. Such lenses can correct vision without a need for a prism ballast and/or a dynamic stabilization element or a need for rotation of the lens to a desired orientation. Such soft contact lenses with a tear lens may have a vaulting portion having a space for a lenticular volume in between the lens and the cornea that can be filled with tear fluid. The lenticular volume forms a lenticular lens that aids in vision correction, together with the soft contact lens. In some cases, the soft contact lens may have at least one fenestration that facilitates filling the lenticular volume. In some cases, at least one fenestration is close to or in constant contact with a tear meniscus of the eye, which allows for a continued tear fluid flow in and out of the lenticular volume during wear. In some cases, the continued fluid flow aids in promoting eye and/or cornea health. In some cases, the continued fluid flow aids in transport of at least one of nutrients, oxygen, or eye lubricating agents, or a combination thereof. In some cases, at least one or more fenestrations may be placed on a traditional toric contact lens with a toric element (e.g., prism ballast or dynamic stabilizer). In some cases, the at least one or more fenestrations in a toric contact lens with a toric element may improve user comfort by providing improved fluid flow and improved transport of at least one of nutrients, oxygen, or eye lubricating agents. In some case, the number and location of the fenestrations are carefully designed to improve user comfort and to ensure constant contact of at least one of the fenestrations with a tear meniscus. In some cases, the number and location of the fenestrations may be affected by capability of the lens to rotate (e.g., free rotation or angle-restricted rotation or no rotation).

The present disclosure is generally directed to vision and treatment of the eye to provide improved vision. Although specific reference is made to coverings for vision correction such as soft contact lenses, embodiments of the present disclosure may comprise additional uses and applications such as the correction of a refractive error or irregularities of an eye, such as, for example an astigmatism.

In one aspect, the present disclosure provides soft contact lenses for correcting vision of an eye of a subject. In some embodiments, the contact lens masks an astigmatism or optical aberration or irregularity of an eye. In some embodiments, the contact lens comprises a soft lens body having an anterior surface, a posterior surface, and at least one fenestration traversing between the anterior surface and the posterior surface. The posterior surface of the lens body may be configured to form, when applied over a corneal surface of the eye with an eyelid of the eye open, a conforming portion substantially conforming to a relatively flat region of the corneal surface and a vaulted portion forming a lenticular volume between a relatively steep region of the corneal surface and the posterior surface of the body. The at least one fenestration may be configured to configured to be positioned adjacent to a tear meniscus, for example, to promote flow of tear fluid therefrom to the lenticular volume, forming a tear lens, when the lens body is applied over the corneal surface with the eyelid of the eye open.

The lenticular volume under the lens which is over the steeper corneal areas may be pushed peripherally and potentially outside the lens with every blink. Once the lens conforms to the cornea over the steeper meridians, a negative pressure can form under the lens in these areas. Such negative pressure can be harnessed to draw fluid back and replenish the tear volume under the lens over the steeper meridians. Hence, replenishing of such fluid volume under the lens may be required in order to maintain its function for masking irregularities using the lenticula fluid volume. Replenishing of such tear fluid occurs via one or a plurality of fenestrations. To achieve optimal replenishing (e.g., rapid replenishing such that the user does not experience vision different from their best pre-blink vision), the fenestration(s) should preferably have access to a relatively large pool of tear fluid. While there is tear fluid over the anterior surface of the lens, such tear film is very thin (~3 microns) and may not allow efficient and rapid fluid movement into the fenestration(s) and under the lens. However, if such fenestration(s) have access to larger pools of fluid volume, such replenishing can occur in better clinically desirable manner. The tear meniscus is the eye is a significantly larger pool of fluid relative to the tear film over the anterior face of the lens—an approximately ten times or more larger pool.

In some embodiments, the tear lens is configured to at least partially correct an astigmatism of the eye. The tear lens may be configured to at least partially correct an optical aberration of the eye.

In some embodiments, the at least one fenestration has a geometry configured to promote the flow of the tear fluid from the tear meniscus to the lenticular volume. In some embodiments, the at least one fenestration is configured to be positioned adjacent the tear meniscus to promote flow of tear fluid therefrom to the lenticular volume from adjacent the anterior surface of the lens body to the posterior surface of the lens body and to the lenticular volume.

In some embodiments, the tear meniscus is one or more of an upper meniscus or a lower meniscus of the eye of the subject.

In some embodiments, the at least one fenestration is configured to be positioned adjacent to the tear meniscus to promote flow of tear fluid to the lenticular volume irrespective of an orientation of the lens body to the tear meniscus, when the lens body is applied over the corneal surface with the eyelid of the eye open.

In some embodiments, the at least one fenestration is configured to be positioned adjacent to the tear meniscus to promote flow of tear fluid to the lenticular volume where the contact lens does not comprise a toric element (e.g., prism ballast, dynamic stabilization, peri-ballast, truncation) to rotationally orient the contact lens.

In some embodiments, the at least one fenestration is configured to be positioned adjacent to the tear meniscus to promote flow of tear fluid to the lenticular volume where the contact lens comprises a toric element (e.g., prism ballast, dynamic stabilization, peri-ballast, truncation) to rotationally orient the contact lens. Such a toric element can be used for aligning the at least one fenestration with the tear meniscus. In some embodiments, a toric element does not require customization related to the orientation of the corneal topography and/or astigmatism.

In some embodiments, the at least one fenestration is configured to be positioned adjacent to the tear meniscus at a distance from about 0.0 mm to about 4 mm away, when the lens body is applied over the corneal surface with the eyelid of the eye open. At a distance of 0.0 mm, the at least one fenestration that is adjacent the tear meniscus would overlap with and be in direct contact and fluid communication with the tear meniscus. At distances greater than 0.0 mm, the at least one fenestration that is adjacent the tear meniscus would be near the tear meniscus and in significant fluid communication therewith, i.e., most of the tear fluid traversing through the at least one fenestration would originate from the tear meniscus. In some embodiments, the at least one fenestration is positioned from about 3 mm to about 9 mm from a center of the lens body. In some embodiments, the at least one fenestration is positioned from about 5 mm to about 8 mm from the center of the lens body.

In some embodiments, the at least one fenestration comprises a plurality of fenestrations. The plurality of fenestration may be evenly distributed around the center of the soft lens body. The plurality of fenestrations may be distributed non-evenly around the center of the soft lens body. The plurality of fenestrations can be distributed circumferentially. The plurality of fenestrations can be distributed radially. At least one fenestration of the plurality of fenestrations can be separated from an adjacent fenestration by a distance of about 1 mm. The plurality of fenestrations can be distributed along at least one meridian of the soft lens body. The radius defined by the plurality of fenestrations distributed radially can be from about 3 mm to about 8 mm. The plurality of fenestrations can be positioned from about 3 mm to about 9 mm from the center of the soft lens body. The plurality of fenestrations can be distributed along a length of the soft lens body. The length of the soft lens body may be a radius, diameter, or circumference of the lens body. The length of the soft lens body can be from about 4 mm to about 45 mm.

In some embodiments, a length of the at least one fenestration from the anterior surface to the posterior surface is from about 40 μm to about 600 μm. The at least one fenestration may have a cross-sectional area from about 0.0001 mm² to about 1 mm². The at least one fenestration may have a cross-sectional area that is circular in shape. The at least one fenestration may comprise from 1 to 25 fenestrations.

In some embodiments, the soft lens body is made of a soft material.

Some embodiments also include methods of correcting vision. An exemplary method may comprise applying at least one of the contact lenses described herein over the corneal surface of the eye of the subject with the eyelid of said eye open.

While it may seem that different corneal base curve of different subjects should require providing a set of lenses with a wide range of base curves to allow for best fitting, it was found that very little or no fitting of lens base curve is required to fit a wide range of corneal base curves. Some embodiments herein also include methods for correcting vision of a subject. An exemplary method may include steps of identifying a subject in need of vision correction, including masking of astigmatism or an optical aberration of an eye of the subject, and providing at least one of the contact lenses described herein to the subject, with minimal need for fitting of a base curve of the at least one contact lens to a base curve of a cornea of the subject, and in some cases, no fitting of the base curve of the at least one contact lens to the base curve of the cornea.

Some embodiments herein also include methods for correcting vision of a subject. An exemplary method for correcting vision of a subject may comprise identifying a subject in need of vision correction, including masking of astigmatism or an optical aberration of an eye of the subject, and providing the at least one contact lens to the subject, which may comprise (i) measuring the astigmatism, optical aberration, or other refractive error of the eye of the subject and (ii) selecting a contact lens suitable for correcting the vision of the eye, including masking any astigmatism or optical aberration, from a group of the contact lenses. The group may number less than 18 contact lenses, i.e., the typical number of standard contact lenses provided in a kit to cover the range of astigmatisms a subject may have, for example, the kit may provide 17, 16, 15, 14, 13, 12, 11, 10, 9, 8, 7, 6, 5, 4, 3, or 2 lenses, or even just 1 lens.

In another aspect, the present disclosure provides methods for correcting vision of an eye of a subject In some embodiments, the method comprises the step of applying a contact lens having a soft lens body and at least one fenestration over a corneal surface of the eye of the subject with an eyelid of said eye open so that the posterior surface of the lens body forms a conforming portion substantially conforming to a relatively flat region of the corneal surface and a vaulted portion forming a lenticular volume between a relatively steep region of the cornea and the posterior surface of the lens body. The at least one fenestration may be positioned adjacent to a tear meniscus, for example, to promote flow of tear fluid therefrom to the lenticular volume, forming a tear lens. The at least one fenestration may be positioned adjacent to a tear meniscus to promote flow of tear fluid therefrom to the lenticular volume, forming a tear lens.

In some embodiments, the tear lens is configured to at least partially correct the astigmatism of the eye. The tear lens may be configured to at least partially correct the optical aberration of the eye.

In some embodiments, the at least one fenestration positioned adjacent the tear meniscus to promote flow of tear fluid therefrom to the lenticular volume from adjacent the anterior surface of the lens body to the posterior surface of the lens body and to the lenticular volume.

In some embodiments, the tear meniscus is one or more of an upper meniscus or a lower meniscus of the eye of the subject.

In some embodiments, the at least one fenestration is positioned adjacent to the tear meniscus to promote flow of tear fluid therefrom to the lenticular volume irrespective of an orientation of the lens body to the tear meniscus, when the lens body is applied over the corneal surface with the eyelid of the eye open.

In some embodiments, the at least one fenestration is positioned adjacent to the tear meniscus at a distance from about 0.0 mm to about 4 mm away, when the lens body is applied over the corneal surface with the eyelid of the eye open. At a distance of 0.0 mm, the at least one fenestration that is adjacent the tear meniscus would overlap with and be in direct contact and fluid communication with the tear meniscus. At distances greater than 0.0 mm, the at least one fenestration that is adjacent the tear meniscus would be near the tear meniscus and in significant fluid communication therewith, i.e., most of the tear fluid traversing through the at least one fenestration would originate from the tear meniscus. In some embodiments, the at least one fenestration is positioned from about 3 mm to about 9 mm from a center of the lens body. In some embodiments, the at least one fenestration is positioned from about 5 mm to about 8 mm from the center of the lens body.

In one aspect, the present disclosure provides a contact lens for correcting vision of an eye of a subject, the contact lens comprising: a soft lens body having an anterior surface, a posterior surface, and at least one fenestration traversing between the anterior surface and the posterior surface; wherein the posterior surface of the lens body is configured to form, when applied over a corneal surface of the eye with an eyelid of the eye open, a conforming portion substantially conforming to a relatively flat region of the corneal surface and a vaulted portion forming a lenticular volume between a relatively steep region of the corneal surface and the posterior surface of the lens body; wherein the at least one fenestration is configured to be positioned adjacent to a tear meniscus when the lens body is applied over the corneal surface with the eyelid of the eye open.

In some embodiments, at least one fenestration is configured to be positioned adjacent to the tear meniscus to promote flow of tear fluid therefrom to the lenticular volume, forming a tear lens, when the lens body is applied over the corneal surface with the eyelid of the eye open.

In some embodiments, the tear lens is configured to at least partially correct an astigmatism of the eye.

In some embodiments, the tear lens is configured to at least partially correct an optical aberration of the eye.

In some embodiments, at least one fenestration has a geometry configured to promote the flow of the tear fluid from the tear meniscus to the lenticular volume.

In some embodiments, at least one fenestration is configured to be positioned adjacent the tear meniscus to promote flow of tear fluid therefrom to the lenticular volume from adjacent the anterior surface of the lens body to the posterior surface of the lens body and to the lenticular volume.

In some embodiments, the tear meniscus is one or more of an upper meniscus or a lower meniscus of the eye of the subject.

In some embodiments, at least one fenestration is configured to be positioned adjacent to the tear meniscus to promote flow of tear fluid to the lenticular volume irrespective of an orientation of the lens body to the tear meniscus, when the lens body is applied over the corneal surface with the eyelid of the eye open.

In some embodiments, at least one fenestration is configured to be positioned adjacent to the tear meniscus to promote flow of tear fluid to the lenticular volume.

In some embodiments, a contact lens does not comprise a rotational orientation feature.

In some embodiments, a rotation orientation feature comprises a prism ballast or a stabilizing dynamic element.

In some embodiments, at least one fenestration is configured such that one fenestration of the at least one fenestration is constantly adjacent to the tear meniscus during wear.

In some embodiments, a contact lens comprises a rotational orientation feature.

In some embodiments, a rotation orientation feature comprises a prism ballast or a stabilizing dynamic element.

In some embodiments, a rotation orientation feature is not customized to a corneal topography or astigmatism.

In some embodiments, at least one fenestration is configured to be positioned adjacent to the tear meniscus at a distance from about 0.0 mm to about 4 mm away, when the lens body is applied over the corneal surface with the eyelid of the eye open.

In some embodiments, at least one fenestration is positioned from about 3 mm to about 9 mm from a center of the lens body.

In some embodiments, at least one fenestration is positioned from about 5 mm to about 8 mm from the center of the lens body.

In some embodiments, at least one fenestration comprises a plurality of fenestrations.

In some embodiments, a plurality of fenestration is evenly distributed around the center of the soft lens body.

In some embodiments, a plurality of fenestrations is distributed non-evenly around the center of the soft lens body.

In some embodiments, a plurality of fenestrations is distributed circumferentially.

In some embodiments, a plurality of fenestrations is distributed radially.

In some embodiments, adjacent fenestrations are separate from one another by a distance of about 1 mm.

In some embodiments, a plurality of fenestrations is distributed along at least one meridian of the soft lens body.

In some embodiments, a radius defined by the plurality of fenestrations distributed radially is from about 3 mm to about 8 mm.

In some embodiments, a plurality of fenestrations is positioned from about 3 mm to about 9 mm from the center of the soft lens body.

In some embodiments, a plurality of fenestrations is distributed along a length of the soft lens body.

In some embodiments, at least one fenestration of the plurality of fenestrations is constantly positioned adjacent to the tear meniscus.

In some embodiments, a length of the soft lens body is a radius, diameter, or circumference of the lens body.

In some embodiments, a length of the soft lens body is from about 4 mm to about 45 mm.

a length of at least one fenestration from the anterior surface to the posterior surface is from about 40 μm to about 600 μm.

In some embodiments, at least one fenestration has a cross-sectional area from about 0.0001 mm² to about 1 mm².

In some embodiments, at least one fenestration has a cross-sectional area that is circular in shape.

In some embodiments, at least one fenestration comprises from 1 to 25 fenestrations.

In some embodiments, a soft lens body is made of a soft material.

In another aspect, the present disclosure provides a method of correcting vision of an eye of a subject, the method comprising applying a contact lens of the disclosure over the corneal surface of the eye of the subject with the eyelid of said eye open.

In another aspect, the present disclosure provides a method for correcting vision of an eye of a subject, the method comprising: identifying a subject in need of vision correction, including masking of astigmatism or an optical aberration of an eye of the subject; and providing, to the subject, a contact lens of the disclosure with minimal need for fitting of a base curve of the contact lens to a base curve of a cornea of the eye of the subject.

In some embodiments, a contact lens is provided to the subject with no fitting of the base curve of the contact lens to the eye of the subject.

In another aspect, the present disclosure provides a method for correction vision of an eye of a subject, the method comprising: applying a contact lens having a soft lens body and at least one fenestration over a corneal surface of the eye of the subject with an eyelid of said eye open so that the posterior surface of the lens body forms a conforming portion substantially conforming to a relatively flat region of the corneal surface and a vaulted portion forming a lenticular volume between a relatively steep region of the cornea and the posterior surface of the lens body, wherein the at least one fenestration is positioned adjacent to a tear meniscus.

In some embodiments, at least one fenestration is positioned adjacent to the tear meniscus to promote flow of tear fluid therefrom to the lenticular volume, forming a tear lens.

In some embodiments, a tear lens is configured to at least partially correct an astigmatism of the eye.

In some embodiments, a tear lens is configured to at least partially correct an optical aberration of the eye.

In some embodiments, at least one fenestration has a geometry configured to promote the flow of the tear fluid from the tear meniscus to the lenticular volume.

In some embodiments, at least one fenestration positioned adjacent the tear meniscus to promote flow of tear fluid therefrom to the lenticular volume from adjacent the anterior surface of the lens body to the posterior surface of the lens body and to the lenticular volume.

In some embodiments, a tear meniscus is one or more of an upper meniscus or a lower meniscus of the eye of the subject.

In some embodiments, at least one fenestration is positioned adjacent to the tear meniscus to promote flow of tear fluid therefrom to the lenticular volume irrespective of an orientation of the lens body to the tear meniscus, when the lens body is applied over the corneal surface with the eyelid of the eye open.

In some embodiments, at least one fenestration is configured to be positioned adjacent to the tear meniscus at a distance from about 0.0 mm to about 4 mm away, when the lens body is applied over the corneal surface with the eyelid of the eye open.

In some embodiments, at least one fenestration is positioned from about 3 mm to about 9 mm from a center of the lens body.

In some embodiments, at least one fenestration is positioned from about 5 mm to about 8 mm from the center of the lens body.

In some embodiments, at least one fenestration comprises a plurality of fenestrations.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the present disclosure are set forth with particularity in the appended claims. A better understanding of the features and advantages of the present disclosure will be obtained by reference to the following detailed description that sets forth illustrative embodiments, in which the principles of the present disclosure are utilized, and the accompanying drawings (also “Figure” and “FIG.” herein), of which:

FIG. 1 is an illustration depicting the anatomy of an eye.

FIG. 2A is an illustration depicting a side view of a soft contact lens with fenestrations distributed circumferentially, according to some embodiments of the present disclosure.

FIG. 2B is an illustration depicting a front view of a soft contact lens with fenestrations distributed circumferentially, according to some embodiments of the present disclosure.

FIG. 2C is an illustration depicting the soft contact lens of FIGS. 2A and 2B applied over the surface of the cornea of an eye, the lens having fenestrations distributed circumferentially and positioned adjacent to the upper and lower tear menisci.

FIG. 2D is an illustration depicting a corneal surface over which the soft contact lens of FIGS. 2A-2C is disposed.

FIG. 3A is a side view of a soft contact lens with fenestrations distributed radially, according to some embodiments of the present disclosure.

FIG. 3B is a front view of a soft contact lens with fenestrations distributed radially, according to some embodiments of the present disclosure.

FIG. 3C is an illustration depicting a soft contact lens of FIGS. 3A and 3B disposed over the surface of the cornea of an eye, the lens having fenestrations distributed circumferentially and positioned proximal to the upper and lower tear menisci.

FIG. 3D shows a corneal surface over which the soft contact lens of FIGS. 3A-3B is disposed.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments, however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

### Definitions

Unless otherwise defined, all technical terms used herein have the same meaning as commonly understood by one of ordinary skill in the art to which this disclosure belongs. As used herein, the singular forms “a,” “an,” and “the” include plural references unless the context clearly indicates otherwise. Any reference to “or” herein is intended to encompass “and/or” unless otherwise stated. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present disclosure.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” “less than or equal to,” or “at most” precedes the first numerical value in a series of two or more numerical values, the term “no more than,” “less than,” “less than or equal to,” or “at most” applies to each of the numerical values in that series of numerical values. For example, less than or equal to 3, 2, or 1 is equivalent to less than or equal to 3, less than or equal to 2, or less than or equal to 1.

Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Many of the features of the present disclosure are described in relation to the anatomy of the eye of a subject. The eye includes several tissues that allow a subject or an individual to see. The subject may be an animal. The subject may be a human, such as a human patient. The subject may be in need of vision treatment, such as treatment for one or more refractive errors of the eye, including myopia, hyperopia, astigmatism, coma or comatic aberration, or other optical aberrations. The cornea of the eye is an anterior region of the eye that is clear in healthy eyes and refracts light in combination with the natural lens of the eye to focus light on the retina. The retina is a posterior region of the eye that senses the light focused thereon and transmits signals indicative of the focused light to the brain, which forms an image based on the sensed and focused light. The cornea includes an outer layer of tissue, the epithelium, which protects the underlying tissues of the cornea, such as Bowman's membrane, the stroma and nerve fibers that extend into the stroma and Bowman's membrane. A healthy eye includes a tear film disposed over the epithelium. The tear film can smooth small irregularities of the epithelium to provide an optically smooth surface. The tear film is shaped substantially by the shape of the underlying epithelium, stroma, and Bowman's membrane, if present. The tear film comprises a liquid that is mostly water but also includes additional components, such as mucoids and lipids. The many nerve fibers of the cornea provide sensation to promote blinking that can cover the cornea with the tear film. The nerve fibers also sense pain so that a subject will normally avoid trauma to the cornea and also avoid direct contact of an object to the cornea.

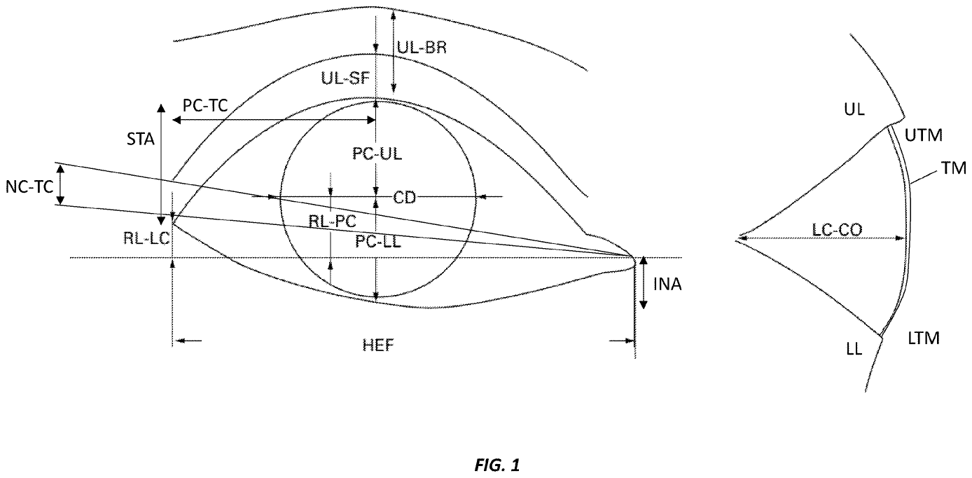

FIG. 1 is an illustration depicting the anatomy of an eye. The eye includes a Horizontal Eyelid Fissure (“HEF”) defined by the distance between the nasal and temporal canthi; a Nasal Canthus to Temporal Canthus (“NC-TC”) defined by the vertical distance between the nasal and temporal canthus, for example, when the NC-TC value is greater than 0, the nasal canthus is higher (i.e., superior to) than the temporal canthus; a Pupil Center to Temporal Canthus (“PC-TC”) defined by the horizontal distance from the pupil the pupil to the temporal canthus; a Pupil Center to Upper Lid (“PC-UL”) defined by the vertical distance from the pupil center to the upper eyelid; a Pupil Center to Lower Lid (“PC-LL”) defined by the vertical distance from the pupil center to the lower eyelid; a Palpebral Aperture (“PA”) defined by the vertical distance between the upper and lower eyelid as measured at the pupil center (i.e., the sum of PC-UL and PC-LL); an Inferior Nasal Aperture (“INA”) defined by the vertical distance from the nasal canthus to the lower eyelid; a Superior Temporal Aperture (“STA”) defined by the vertical distance from the temporal canthus to the upper eyelid; a Theta Horizontal Eyelid Fissure (“Theta HEF”) defined by the angle between the temporal and nasal canthus, for example, when the Theta HEF value is greater than 0, the nasal canthus is higher (i.e., superior to) than the temporal canthus; a Theta Upper Lid (Theta-UL) defined by the angle between the line joining the two points where the upper eyelid intersects the limbus and the horizontal, for example, when the Theta-UL value is greater than 0, the nasal portion of the central upper eyelid is higher (i.e., superior to) than the temporal portion of the central upper eyelid; and a Theta Lower Lid (Theta-LL) defined by the angle between the line joining two points where the lower lid intersects the limbus and the horizontal, for example, when the Theta-LL value is greater than 0, the nasal portion of the central lower eyelid is higher (i.e., superior to) than the temporal portion of the central lower eyelid.

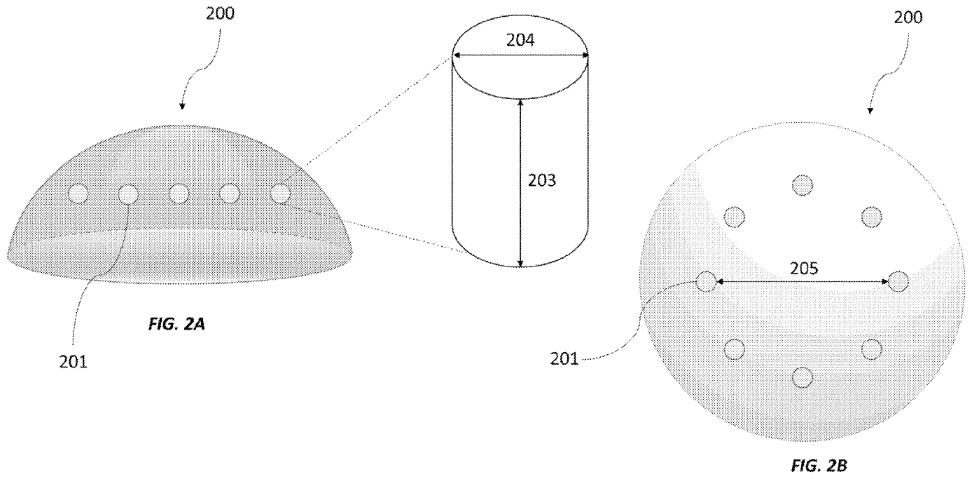

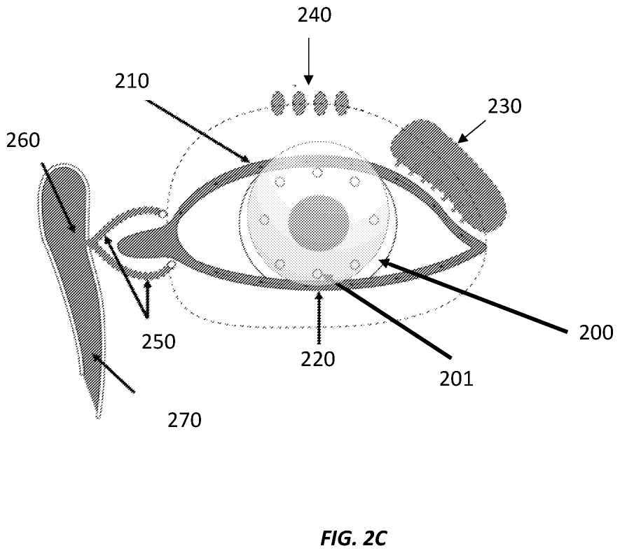

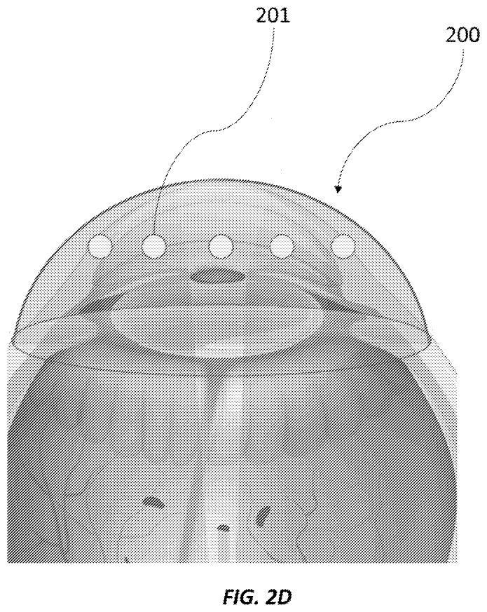

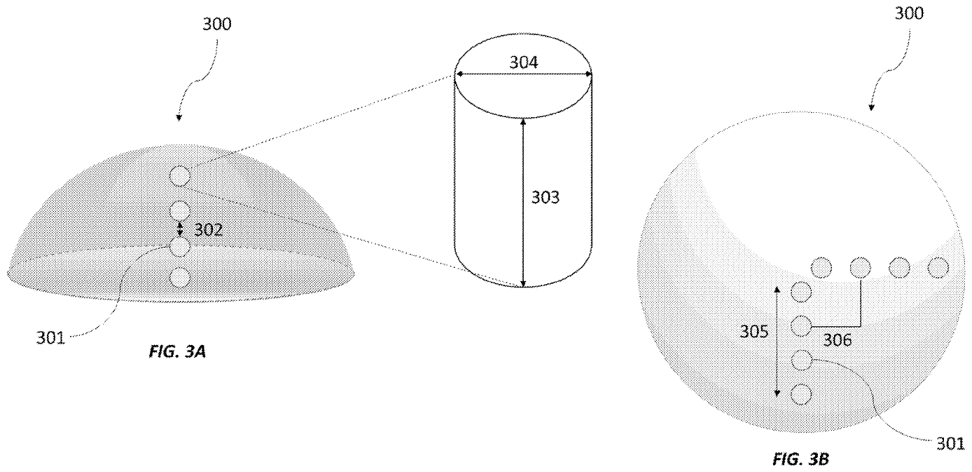

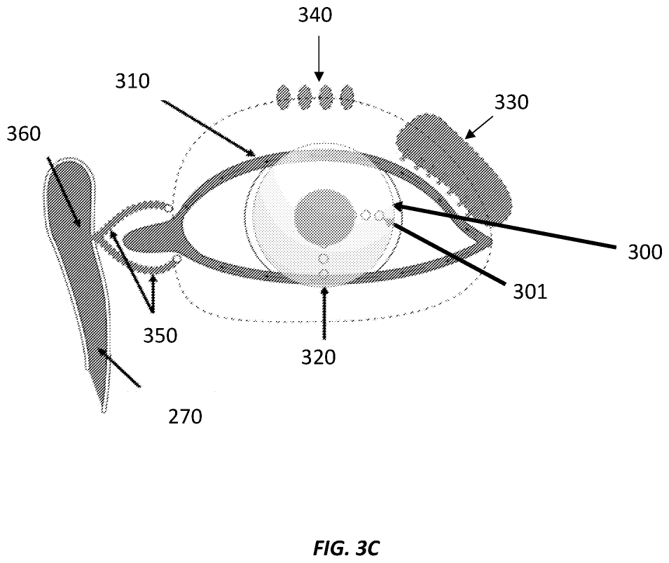

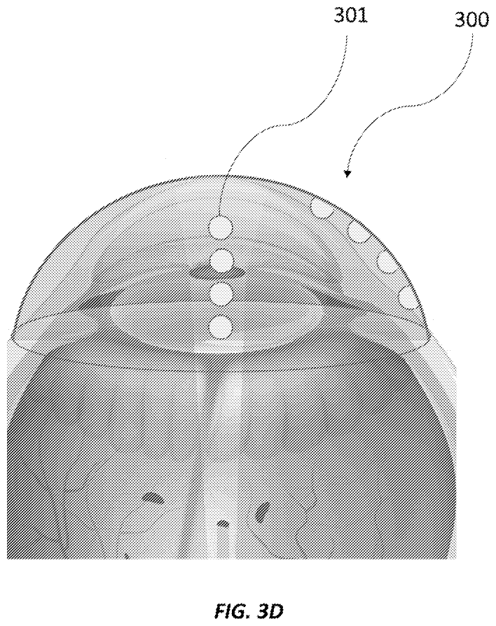

Described herein are contact lenses with improved fluid flow for forming a tear lens over a corneal surface of an eye having an astigmatism or optical aberration. FIGS. 2A, 2B, 2C, 2D, 3A, 3B, 3C, and 3D are illustrations depicting various perspectives of the contact lenses of the present disclosure, accordingly to some embodiments. The contact lens of the present disclosure may comprise a soft lens body. In some embodiments, the soft lens body has an anterior surface, a posterior surface, and at least one fenestration traversing between the anterior surface and the posterior surface. The posterior surface of the lens body may be configured to form, when applied over a corneal surface of the eye with an eyelid of the eye open, a conforming portion substantially conforming to a relatively flat region of the corneal surface and a vaulted portion forming a lenticular volume between a relatively steep region of the corneal surface and the posterior surface of the lens body. The vaulted portion may be supported over the relatively steep region of the corneal surface by the conforming portion. An astigmatic eye may have meridians which are steeper than others. The conforming portions of the posterior surface may contact the meridians of the eye which are relatively flatter while the non-conforming, vaulting portions may vault over the relatively steeper meridians. The non-conforming, vaulting portions may be supported by the conforming portions. In such relatively steeper meridians, the vaulting portion(s) may form a lenticular volume between the posterior surface of the contact lens and the corneal surface, and this lenticular volume may fill with tear fluid forming a tear lens which provides optical power and/or optical correction to the eye, including masking of the astigmatism or other optical aberration. Tear fluid may comprise water, electrolytes (such as sodium), fatty oils, proteins, or combinations thereof. Tear fluid may impart an effect on vision, lubrication (e.g., of the eye), ocular health and/or ocular function. The posterior surface of the contact lens may further comprise further conforming portions at the periphery of contact lens to provide further support to the non-conforming, vaulting portions. The at least one fenestration of the contact lenses may be configured to be positioned adjacent to a tear meniscus, for example, to promote flow of tear fluid therefrom to the lenticular volume, forming a tear lens, when the soft lens body is applied over the corneal surface with the eyelid of the eye open.

Standard soft contact lenses typically conform to the corneal surface due to adhesion forces between the posterior surface of the lens and the corneal surface and downward pressure caused by the eyelids during blinking. In an irregular or astigmatic cornea, the standard soft contact lenses will generally assume the shape of the irregularity or astigmatism of the cornea upon conforming to the corneal surface. Accordingly, the anterior surface of the standard soft contact lenses will generally assume the shape of the anterior surface of the cornea (and forming no lenticular volume or tear lens as described above). For example, following a blink, downward pressure from the eyelid will cause the standard soft contact lenses to immediately assume the shape of the anterior surface of the cornea. The conformation of the contact lens to the corneal surface causes the displacement of fluid from between the lens and the corneal surface.

If a fluid, such as tear fluid or artificial tear fluid, does not flow or does not flow rapidly enough (i.e., the fluid has a low transport capacity) to access the space between the posterior surface of the contact lens and the corneal surface, the lens may not fully correct for an astigmatism, particularly for contact lenses which rely on the formation of a tear lens to correct the astigmatism or other optical aberration. Thus, the subject wearing the limited flow, soft contact lens may experience reduced vision for a period of time. For such a contact lens to function with no or minor visual disturbance, the lens body itself should be capable of masking about 0.25D, or more, for the wearer to have little or no awareness that the lens has assumed an irregular shape during blinking.

In standard soft contact lenses, fenestrations and/or pores are typically used to facilitate increased oxygen supply to the cornea than for a contact lens without fenestrations and/or pores. However, although these types of fenestrations connect the anterior surface of the lens to the posterior surface of the lens, they do not allow a fluid from the tear film that resides on the anterior surface of the contact lens to be transported through the fenestrations to the lenticular volume between the posterior surface of the lens and the steep regions of the corneal surface.

The contact lenses of the present disclosure include at least one fenestration configured to promote a fluid, such as tear fluid or artificial tear fluid, to flow between the posterior surface of the contact lens and the corneal surface of an eye. In some embodiments, a conforming portion of the lens overlying relatively flat regions of the corneal surface supports a non-conforming, vaulting or vaulted portion of the lens allowing the fluid to fill a lenticular volume formed between the vaulted portions of lens and the steep regions of the cornea. By filling the lenticular volume between posterior surface of the lens and the steep regions of the cornea the lens may assume a shape that is closer to its neutral configuration (i.e., “as-manufactured” shape). In some embodiments, the vaulting of the contact lens facilitates filling of the lenticular volume with the fluid. In some embodiments, the at least one fenestration allows for increased oxygen transport through the lens to the cornea than for a contact lens with pores only. In some embodiments, the at least one fenestration allows for increased oxygen transport through the lens to the cornea than for a contact lens with no pores and/or no fenestrations.

Factors that determine fluid flow across a contact lens include fluid availability, resistance of flow, lens material properties such as chemical properties (e.g., hydrophilicity or hydrophobicity), mechanical properties (e.g., modulus and elasticity), the geometrical shape of the lens, or a combination thereof.

### Fluid Availability

To provide adequate fluid flow to the lenticular volume, a contact lens should be able to access a fluid source with sufficient volume. Typically, the total accessible tear volume is between about 1.5 μL and about 7 μL, 75% to 90% of which is held in the tear menisci. Often, the remaining tear volume is held over the surface of the eye and/or between the eyelids. The height of the lower tear meniscus (“LTM”) is between about 0.1 mm and about 0.3 mm (e.g., about 0.2 to about 0.3 mm). For example, if the at least one fenestration of the contact lens is positioned such that it can only access tear film (roughly 310 micrometer (“μm”) thick) overlying the anterior surface of the lens, the lens may not perform as intended due to the insufficient accessible tear fluid volume. Therefore, simply placing fenestrations at arbitrary locations may not provide adequate fluid availability or fluid flow properties to allow the fluid to fill the lenticular volume.

FIGS. 2C and 3C are illustrations depicting the contact lenses of the present disclosure disposed over the corneal surface of the eye having fenestrations adjacent to the tear meniscus.

In some embodiments, the at least one fenestration, fenestration 201 and/or 301, for example, is positioned adjacent to the tear meniscus or tear menisci (i.e., the volume of tear fluid resting at the junction of the bulbar conjunctiva and the lower eyelid margin), which hold approximately 75% to 90% or of the total tear volume of the exposed ocular surface. In some embodiments, tear fluid is produced by the main lacrimal gland (230 or 330) and/or accessory lacrimal glands (240 or 340), as shown in FIGS. 2C and 3C. In some embodiments, the tear meniscus may be one or more of an upper meniscus (210 or 320) or lower meniscus (220 or 320), as shown in FIGS. 2C and 3C. In some embodiments, tear fluid drains from an upper meniscus or lower meniscus to a canaliculi (250 or 350) into a lacrimal sac (260 or 360) and through a nasolacrimal duct (270) or 370), as shown in FIGS. 2C and 3C.

In some embodiments, the at least one fenestration, 201 and/or 301, being adjacent to the tear meniscus means that the at least one fenestration is at least about 0 mm, at least 0.1 mm, at least 0.2 mm, at least 0.3 mm, at least 0.4 mm, at least 0.5 mm, at least 0.6 mm, at least 0.7 mm, at least 0.8 mm, at least 0.9 mm, at least 1 mm, at least 1.1 mm, at least 1.2 mm, at least 1.3 mm, at least 1.4 mm, at least 1.5 mm, at least 1.6 mm, at least 1.7 mm, at least 1.8 mm, at least 1.9 mm, at least 2 mm, at least 2.1 mm, at least 2.2 mm, at least 2.3 mm, at least 2.4 mm, at least 2.5 mm, at least 2.6 mm, at least 2.7 mm, at least 2.8 mm, at least 2.9 mm, at least 3.0 mm, at least 3.1 mm, at least 3.2 mm, at least 3.3 mm, at least 3.4 mm, at least 3.5 mm, at least 3.6 mm, at least 3.7 mm, at least 3.8 mm, at least 3.9 mm, at least 4.0 mm, or any values therebetween, from the closest tear meniscus (e.g., when measured from a border of the tear meniscus or when measured from a center of the tear meniscus). In some embodiments, the at least one fenestration, 201 and/or 301, being adjacent to the tear meniscus means that the at least one fenestration is at most about 4.0 mm, at most 3.9 mm, at most 3.8 mm, at most 3.7 mm, at most 3.6 mm, at most 3.5 mm, at most 3.4 mm, at most 3.3 mm, at most 3.2 mm, at most 3.1 mm, at most 3.0 mm, at most 2.9 mm, at most 2.8 mm, at most 2.7 mm, at most 2.6 mm, at most 2.5 mm, at most 2.4 mm, at most 2.3 mm, at most 2.2 mm, at most 2.1 mm, at most 2.0 mm, at most 1.9 mm, at most 1.8 mm, at most 1.7 mm, at most 1.6 mm, at most 1.5 mm, at most 1.4 mm, at most 1.3 mm, at most 1.2 mm, at most 1.1 mm, at most 1.0 mm, at most 0.9 mm, at most 0.8 mm, at most 0.7 mm, at most 0.6 mm, at most 0.5 mm, at most 0.4 mm, at most 0.3 mm, at most 0.2 mm, at most 0.1 mm, at most or 0.1 mm or any values therebetween, from the closest tear menisci (e.g., when measured from a border of the tear meniscus or when measured from a center of the tear meniscus). The distance between the at least one fenestration, 201 and/or 301, and the tear menisci may be within a range defined by any two of the preceding values. For instance, the distance between the at least one fenestration, 201 and/or 301, and the tear menisci may be from about 0 mm to about 4 mm, for example, from about 0.1 mm to about 4 mm or from 0.1 mm to about 1.0 mm. In some embodiments, a position of the fenestrations in relation to the tear meniscus changes depending on whether the eye is held in a primary gaze or in a downward gaze. In some embodiments, a position of the fenestrations in relation to the tear meniscus changes as the eye changes between a primary gaze and a downward gaze. In some embodiments, at least one fenestration is adjacent to the tear meniscus at a distance of about 0 mm or more regardless on the gaze (e.g., primary gaze or downward gaze). In some embodiments, at least one fenestration is in contact with the tear meniscus even when the eye gaze position changes. In some embodiments, at least one fenestration covers a portion of the tear meniscus. In some embodiments, at least one fenestration covers a portion of the tear meniscus even when the eye gaze position changes. At a distance of 0 mm, the fenestration, 201 and/or 301, that is adjacent the tear meniscus may overlap with and be in direct contact and fluid communication with the tear meniscus. At distances greater than 0 mm, the fenestration, 201 and/or 301, that is adjacent the tear meniscus may be near the tear meniscus and in significant fluid communication therewith, i.e., most of the tear fluid traversing through the at least one fenestration would be originate from the tear meniscus.

In some embodiments, the at least one fenestration, 201 and/or 301, is positioned proximal (e.g., near) the tear menisci irrespective of the rotational position of the lens (i.e., the angle of the lens relative to a meridian of the eye).

The tear menisci may possess an excess fluid volume relative to what is needed to fill the lenticular volume(s) residing between the posterior surface of the lens and corneal surface. In some embodiments, the at least one fenestration is positioned adjacent to the tear menisci of the eye.

In some embodiments, the at least one fenestration is a plurality of fenestrations distributed over a length (i.e., a radius, diameter, circumference, or combination thereof) of the contact lens, as shown in FIGS. 2B and 3B. The length over which the fenestrations are distributed over and cover the intrapalpebral fissure (“IPF”) (i.e., the elliptic space between the medial and lateral canthi of the two eyelids) during distance, intermediate and near gazes. The IPF for distance (i.e., primary gaze) is about 9.5±1.0 mm; for intermediate (i.e., 20 degrees gaze) is about 8.0±1.0 mm; and for near (i.e., 40 degrees gaze) is about 6.5±1.0 mm. In some embodiments, the orientation of the fenestration does not affect the capability of the lens to provide vision correction. In some embodiments, the orientation of the fenestration does not affect the capability of the lens to form a lenticular volume filled with a fluid. In some embodiments, the orientation of the fenestration does not affect the capability of the lens to form a lenticular volume with tear fluid as at least one fenestration is in contact with the tear meniscus during wear by a subject.

The at least one fenestration, 201 and/or 301, may be a plurality of fenestrations distributed over a length (i.e., a radius 305, diameter 205, circumference, or combination thereof) the fenestration can be located over the radius (distance from center) of the contact lens that is at least about 2 mm, at least 2.2 mm, at least 2.4 mm, at least 2.6 mm, at least 2.8 mm, at least 3 mm, at least 3.1 mm, at least 3.2 mm, at least 3.3 mm, at least 3.4 mm, at least 3.5 mm, at least 3.6 mm, at least 3.7 mm, at least 3.8 mm, at least 3.9 mm, at least 4 mm, at least 4.1 mm, at least 4.2 mm, at least 4.3 mm, at least 4.4 mm, at least 4.5 mm, at least 4.6 mm, at least 4.7 mm, at least 4.8 mm, at least 4.9 mm, at least 5 mm, at least 5.1 mm, at least 5.2 mm, at least 5.3 mm, at least 5.4 mm, at least 5.5 mm, at least 5.6 mm, at least 5.7 mm, at least 5.8 mm, at least 5.9 mm, at least 6.0 mm, at least 6.1 mm, at least 6.2 mm, at least 6.3 mm, at least 6.4 mm, at least 6.5 mm, at least 6.6 mm, at least 6.7 mm, at least 6.8 mm, at least 6.9 mm, at least 7 mm, at least 7.1 mm, at least 7.2 mm, at least 7.3 mm, at least 7.4 mm, at least 7.5 mm 7.6 mm, at least 7.7 mm, at least 7.8 mm, at least 7.9 mm, at least 8 mm, at least 8.1 mm, at least 8.2 mm, at least 8.3 mm, at least 8.4 mm, at least 8.5 mm, at least 8.6 mm, at least 8.7 mm, at least 8.8 mm, at least 8.9 mm, at least 9 mm, at least 9.5 mm, at least 10 mm, at least 10.5 mm, at least 11 mm, at least 11.5 mm, at least 12 mm, at least 13 mm, at least 14 mm, at least 15 mm, at least 16 mm, at least 17 mm, at least 18 mm, at least 19 mm, at least 20 mm, at least 25 mm, at least 30 mm, at least 35 mm, at least 40 mm, at least 45 mm, or any values therebetween. In some embodiments, the fenestrations may be distributed over a length of the contact lens that is at most about 45 mm, at most 40 mm, at most 35 mm, at most 30 mm, at most 25 mm, at most 20 mm, at most 19 mm, at most 18 mm, at most 17 mm, at most 16 mm, at most 15 mm, at most 14 mm, at most 13 mm, at most 12 mm, at most 11.5 mm, at most 11 mm, at most 10.5 mm, at most 10 mm, at most 9.5 mm, at most 9 mm, at most 8.9 mm, at most 8.8 mm, at most 8.7 mm, at most 8.6 mm, at most 8.5 mm, at most 8.4 mm, at most 8.3 mm, at most 8.2 mm, at most 8.1 mm, at most 8 mm, at most 7.9 mm, at most 7.8 mm, at most 7.7 mm, at most 7.6 mm, at most 7.5 mm, at most 7.4 mm, at most 7.3 mm, at most 7.2 mm, at most 7.1 mm, at most 7 mm, at most 6.9 mm, at most 6.8 mm, at most 6.7 mm, at most 6.6 mm, at most 6.5 mm, at most 6.4 mm, at most 6.3 mm, at most 6.2 mm, at most 6.1 mm, at most 6 mm, at most 5.9 mm, at most 5.8 mm, at most 5.7 mm, at most 5.6 mm, at most 5.5 mm, at most 5.4 mm, at most 5.3 mm, at most 5.2 mm, at most 5.1 mm, at most 5 mm, at most 4.9 mm, at most 4.8 mm, at most 4.7 mm, at most 4.6 mm, at most 4.5 mm, at most 4.4 mm, at most 4.3 mm, at most 4.2 mm, at most 4.1 mm, at most 4 mm, at most 3.9 mm, at most 3.8 mm, at most 3.7 mm, at most 3.6 mm, at most 3.5 mm, at most 3.4 mm, at most 3.2 mm, at most 3.1 mm, at most 3 mm, at most 2.8 mm, at most 2.6 mm, at most 2.4 mm, at most 2.2 mm, at most 2 mm, or any values therebetween. The fenestrations may be distributed over a length of the contact lens that may be within a range defined by any two of the preceding values. For instance, the fenestrations may be distributed over a length of the contact lens from radius of about 2 mm to about 7 mm. In an example, the fenestrations may be distributed over a length from radius of about 3 mm to about 6 mm.

In some embodiments, the plurality of fenestrations is evenly distributed (i.e., uniformly distributed) around the center of the body of the lens. In some embodiments, the plurality of fenestrations is non-evenly distributed (i.e., non-uniformly distributed) around the center of the body of the lens.

In some embodiments, the fenestrations are distributed circumferentially about the contact lens. FIGS. 2A and 2B are illustrations depicting a side view and top-down view of a contact lens 200 having circumferential fenestrations 201. In some embodiments, the number of circumferential fenestrations 201 is proportional to the circumference of the circle formed by the circumferential fenestrations 201. The number of circumferential fenestrations 201 may be approximated by the formula π*radius or ½ *π*diameter. For example, when circle formed by the circumferential fenestrations 201 has a 6 mm diameter, then the number of fenestrations is about 9, or approximately half of the circumference of the circle formed by the circumferential fenestrations 201. In another example, when the circle formed by the circumferential fenestrations 201 has a 14 mm diameter then the number of fenestrations is about 21, or approximately half of the circumference of the circle formed by the circumferential fenestrations 201. In some embodiments, the number of fenestrations is at least about 1, at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 21, at least 22, at least 23, at least 24, at least 25, at least 26, at least 27, at least 28, at least 29, at least 30, at least 31, at least 32, at least 33, at least 34, at least 35, at least 36, at least 37, at least 38, at least 39, at least or 40. In some embodiments, the number fenestrations is at most about 40, at most 39, at most 38, at most 37, at most 36, at most 35, at most 34, at most 33, at most 32, at most 31, at most 30, at most 29, at most 28, at most 27, at most 26, at most 25, at most 24, at most 23, at most 22, at most 21, at most 20, at most 19, at most 18, at most 17, at most 16, at most 15, at most 14, at most 13, at most 12, at most 11, at most 10, at most 9, at most 8, at most 7, at most 6, at most 5, at most 4, at most 3, at most 2, at most or 1. In some embodiments, the fenestrations are uniformly distributed about the circumference. In some embodiments, the fenestrations are not uniformly distributed about the circumference.

In some embodiments, the fenestrations are distributed radially. FIGS. 3A and 3B are illustrations depicting a side view and top-down view of a contact lens 300 having radial fenestrations 301. In some embodiments, the radial fenestrations 301 are distributed along at least one axis of the lens body, such as the axis defining a meridian of the lens body. In some embodiments, the radii formed by the radial fenestrations 301 creates one or more sectors of the contact lens. The one or more sectors may be defined by an angle 305 between any two adjacent radial distributions of the at least one fenestration.

In some embodiments, the one or more sectors may have an angle 305 of at least about 1 degree, at least 2 degrees, at least 3 degrees, at least 4 degrees, at least 5 degrees, at least 6 degrees, at least 7 degrees, at least 8 degrees, at least 9 degrees, at least 10 degrees, at least 20 degrees, at least 30 degrees, at least 40 degrees, at least 50 degrees, at least 60 degrees, at least 70 degrees, at least 80 degrees, at least 90 degrees, at least 100 degrees, at least 120 degrees, at least 140 degrees, at least 160 degrees, at least 180 degrees, or any values therebetween. In some embodiments, the one or more sectors may have an angle 305 of at most about 180 degrees, at most 160 degrees, at most 140 degrees, at most 120 degrees, at most 100 degrees, at most 90 degrees, at most 80 degrees, at most 70 degrees, at most 60 degrees, at most 50 degrees, at most 40 degrees, at most 30 degrees, at most 20 degrees, at most 10 degrees, at most 9 degrees, at most 8 degrees, at most 7 degrees, at most 6 degrees, at most 5 degrees, at most 4 degrees, at most 3 degrees, at most 2 degrees, at most 1 degree, or any values therebetween. The one or more sectors may have an angle 305 that may be within a range defined by any two of the preceding values. For instance, the one or more sectors may have an angle 305 from about 1 degree to about 180 degrees. In an example, the one or more sectors has an angle 305 from about 70 degrees to about 90 degrees.

In some embodiments, the lens described herein comprises one or more fenestrations distributed radially from the center of the lens. In some embodiments, radially distributed fenestrations comprise one or more fenestrations extending from about the center of the lens towards the edge of the lens in a line. In some embodiments, a lens comprises one or more radial line of fenestrations. In some embodiments, a lens comprises one radial line of fenestrations. In some embodiments, a lens comprises two radial lines of fenestrations. In some embodiments, a lens comprises three radial lines of fenestrations. In some embodiments, a lens comprises four radial lines of fenestrations.

In some embodiments, a radial line of fenestrations comprises one or more fenestrations. In some embodiments, a radial line of fenestrations comprises one fenestration. In some embodiments, a radial line of fenestrations comprises two fenestrations. In some embodiments, a radial line of fenestrations comprises three fenestrations. In some embodiments, a radial line of fenestrations comprises four fenestrations. In some embodiments, a radial line of fenestrations comprises five fenestrations. In some embodiments, a radial line of fenestrations comprises at most five fenestrations. In some embodiments, a radial line of fenestrations comprises at most four fenestrations. In some embodiments, a radial line of fenestrations comprises at most three fenestrations. In some embodiments, a radial line of fenestrations comprises at most two fenestrations. In some embodiments, a radial line of fenestrations comprises at most one fenestration.

In some embodiments, a lens having two or more radial lines of fenestrations is configured such that an angle between two lines of fenestrations is about 0 degrees to about 180 degrees. In some embodiments, two radial lines of fenestrations is configured to form an angle of about 90 degrees. In some embodiments, two radial lines of fenestrations is configured to form an angle of about 180 degrees. In some embodiments, a lens comprising two or more radial lines of fenestrations does not comprise a toric element. For example, a lens free of a toric element comprising two radial lines of fenestrations that are distributed about 90 degrees apart may provide sufficient access of at least one fenestration to a tear meniscus (e.g., upper or lower tear meniscus) irrespective of the orientation of the lens on the eye.

In some embodiments, a lens comprises one radial line of fenestrations. In some embodiments, a lens comprises two radial lines of fenestrations. In some embodiments, a lens comprises three radial lines of fenestrations. In some embodiments, a lens comprises four radial lines of fenestrations.

In some embodiments, a lens comprising one radial line of fenestrations has a toric element. In some embodiments, the toric element positions the lens when disposed on the eye such that at least one fenestration in the radial line of fenestrations is adjacent to the upper or lower tear meniscus. In some embodiments, the toric element positions the lens such that the toric element is in a downward orientation (e.g., 6 o'clock) when the lens is worn on the eye. In some embodiments, the toric element positions the lens such that the toric element is in an upward orientation (e.g., 12 o'clock) when the lens is worn on the eye.

In some embodiments, at least one fenestration on a lens is adjacent to the tear meniscus. In some embodiments, at least one fenestration of one or more fenestrations on a lens has access to the tear fluid from a tear meniscus (e.g., upper meniscus or lower meniscus) constantly during wear. In some embodiments, at least two fenestrations of one or more fenestrations on a lens is adjacent to the tear meniscus. In some embodiments, at least two fenestrations of one or more fenestrations on a lens has access to the tear fluid from a tear meniscus (e.g., upper meniscus or lower meniscus) during wear. In some embodiment, constant access to the tear meniscus refers to being adjacent or in contact with the tear meniscus for at least 70%, 75%, 80%, 85%, 90%, 95%, 96%, 97%, 98%, or 99% of the time that the user is wearing the contact lens. In some embodiment, constant access is also referred herein as constant contact, continuous contact, or continuous access.

In some embodiments, a lens having fewer fenestrations may be advantageous as the lens is more comfortable for the wearer than a lens having more fenestrations. In some embodiments, minimizing the total number of fenestrations on a lens while increasing the interaction between one or more fenestrations and a tear meniscus provides more comfort to the wearer of the lens in comparison to an otherwise similar lens having a greater number of fenestrations. In some embodiments, the number of fenestrations is chosen to provide the comfort for the user by having fewer surface disruptions (e.g., fenestrations) while providing sufficient tear fluid and oxygen exchange.

Depending on the design of the lens, only 1, 2, 3, 4, 5, 6, 7, 8, 9, or 10 fenestrations may be sufficient to achieve the various functions, including having at least one fenestration have constant access to a tear meniscus. In some embodiments, for a lens with a toric element allowing for a fixed orientation (e.g., no rotation), no more than 1, 2, 3, 4, 5, 6, 7, 8, 9, or 10 fenestrations may be sufficient for at least one fenestration to have constant access to a tear meniscus. In some embodiments, for a lens with a toric element allowing for a fixed orientation (e.g., no rotation), 2 fenestrations may be sufficient for at least one fenestration to have constant access to a tear meniscus. In some embodiments, for a lens with a toric element allowing for a 180-degree orientation (e.g., free 180 rotation), no more than 1, 2, 3, 4, 5, 6, 7, 8, 9, or 10 fenestrations may be sufficient for at least one fenestration to have constant access to a tear meniscus. In some embodiments, for a lens with a toric element allowing for a 180-degree orientation (e.g., free 180 rotation), 4 fenestrations may be sufficient for at least one fenestration to have constant access to a tear meniscus. In some embodiments, for a lens without a toric element (e.g., free rotation), no more than 1, 2, 3, 4, 5, 6, 7, 8, 9, or 10 fenestrations may be sufficient for at least one fenestration to have constant access to a tear meniscus. In some embodiments, for a lens without a toric element (e.g., free rotation), 4 fenestrations may be sufficient for at least one fenestration to have constant access to a tear meniscus.

In some embodiments, at least 10% or more of the fenestrations on a lens are adjacent to a tear meniscus (e.g., upper or lower tear meniscus). In some embodiments, at least 20% or more of the fenestrations on a lens are adjacent to a tear meniscus (e.g., upper or lower tear meniscus). In some embodiments, at least 30% or more of the fenestrations on a lens are adjacent to a tear meniscus (e.g., upper or lower tear meniscus). In some embodiments, at least 40% or more of the fenestrations on a lens are adjacent to a tear meniscus (e.g., upper or lower tear meniscus). In some embodiments, at least 50% or more of the fenestrations on a lens are adjacent to a tear meniscus (e.g., upper or lower tear meniscus). For example, a lens comprising 4 fenestrations may have 25% (e.g., ¼) of the fenestrations adjacent to the tear meniscus. For example, a lens comprising 4 fenestrations distributed in one radial line may have 25% (e.g., ¼) of the fenestrations adjacent to the tear meniscus. For example, a lens comprising 8 fenestrations may have about 12% (e.g., ⅛) of the fenestrations adjacent to the tear meniscus. For example, a lens comprising 8 fenestrations distributed in two radial lines, each comprising 4 fenestrations, and each line being 90 degrees apart, may have about 12% (e.g., ⅛) of the fenestrations adjacent to the tear meniscus.

In some embodiments, a lens comprising a toric element (e.g., dynamic stabilizer or weight) comprises at least one fenestration positioned to be adjacent to either a lower or upper tear meniscus. In some embodiments, a lens comprising a toric element (e.g., dynamic stabilizer or weight) comprises at least two fenestrations, where one fenestration is positioned to be adjacent to the lower tear meniscus and the other fenestration is positioned to be adjacent to the upper tear meniscus. In some embodiments, a lens comprising a toric element (e.g., dynamic stabilizer or weight) comprises at least two fenestrations, where one fenestration is positioned to be adjacent to the lower tear meniscus and is positioned about 3 mm to about 7 mm (e.g., about 5 mm) from the center of the lens while the other fenestration is positioned to be adjacent to the upper tear meniscus and positioned about 2 mm to about 4 mm (e.g., about 3.5 mm) from the center of the lens. In some embodiments, when two or more fenestrations are in a radial line, one fenestration is closer to the center of the lens than another fenestration.

In some embodiments, a lens comprises a toric element (e.g., dynamic stabilizer or weight) and is free to rotate about 180 degrees when disposed on the eye. In some embodiments, a lens comprising a toric element comprises at least two fenestrations, where at least one fenestration is positioned downward (e.g., adjacent to the lower tear meniscus) and at least one fenestration is positioned upward (e.g., adjacent to the upper tear meniscus). In some embodiments, a lens comprising a toric element (e.g., dynamic stabilizer or weight) comprises at least two fenestrations, where at least one fenestration is positioned to be adjacent to the lower tear meniscus and is positioned about 3 mm to about 7 mm (e.g., about 5 mm) from the center of the lens while at least one fenestration is positioned to be adjacent to the upper tear meniscus and positioned about 2 mm to about 7 mm (e.g., about 3.5 mm) from the center of the lens. In some embodiments, when two or more fenestrations are in a radial line, one fenestration is closer to the center of the lens than another fenestration.

In some embodiments, a lens comprises a toric element (e.g., dynamic stabilizer or weight) and is free to rotate about 180 degrees when disposed on the eye. In some embodiments, a lens comprising a toric element comprises at least four fenestrations, where at least two fenestrations are positioned to downward (e.g., adjacent the lower tear meniscus) and at least two fenestrations are positioned upward (e.g., adjacent to the upper tear meniscus). In some embodiments, at least two fenestrations positioned towards the lower tear meniscus are positioned about 2 mm to about 7 mm (e.g., about 3.5 mm and about 5 mm) from the center of the lens. In some embodiments, at least two fenestrations positioned towards the upper tear meniscus are positioned about 2 mm to about 7 mm (e.g., about 3.5 mm and about 5 mm) from the center of the lens. In some embodiments, at least one fenestration is adjacent to either the lower or upper tear meniscus. In some embodiments, when two or more fenestrations are in a radial line, one fenestration is closer to the center of the lens than another fenestration.

In some embodiments, a lens is free of a toric element, and the lens can rotate freely (e.g., without restriction on rotation angle) when disposed on the eye. In some embodiments, a lens free of a toric element comprises at least two fenestrations, where the at least two fenestrations are distributed about 90 degrees apart, such that at least one fenestration is adjacent to either the lower or upper tear meniscus when the lens is disposed on the eye. In some embodiments, a lens free of a toric element comprises at least two fenestrations, where the at least two fenestrations are distributed about 90 degrees apart, and each fenestration is positioned about 2 mm to about 7 mm (e.g., about 3.5 mm or about 5 mm) from the center of the lens, and positioned such that at least one fenestration is adjacent to either the lower or upper tear meniscus when the lens is disposed on the eye. In some embodiments, when two or more fenestrations are in a radial line, one fenestration is closer to the center of the lens than another fenestration.

In some embodiments, a lens is free of a toric element, and the lens is free to rotate when disposed on the eye. In some embodiments, a lens free of a toric element comprises at least four fenestrations, where at least two fenestrations are distributed about 90 degrees apart, such that at least one fenestration is adjacent to either the lower or upper tear meniscus when the lens is disposed on the eye. In some embodiments, a lens free of a toric element comprises at least four fenestrations, where the at least two fenestrations are distributed about 90 degrees apart, and the fenestrations are positioned about 2 mm to about 7 mm (e.g., about 3.5 mm and about 5 mm) from the center of the lens, and positioned such that at least one fenestration is adjacent to either the lower or upper tear meniscus when the lens is disposed on the eye.

In some embodiments, distance 302 between each of the fenestrations distributed radially is about 0.5 mm to about 2 mm. In some embodiments, the distance between each of the fenestrations distributed radially is about 0.5 mm. In some embodiments, the distance between each of the fenestrations distributed radially is about 1 mm. In some embodiments, the distance between each of the fenestrations distributed radially is about 1.5 mm. In some embodiments, the distance between each of the fenestrations distributed radially is about 2 mm.

In some embodiments, the number of fenestrations distributed radially is proportional to the radii formed by the fenestrations distributed radially. For example, if radii of the fenestrations distributed radially is about 8 mm, and the distance between each of the fenestrations distributed radially is about 1 mm, then the number of fenestrations distributed along any given radii is about 4.

In some embodiments, the number fenestrations is at least about 1, at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 21, at least 22, at least 23, at least 24, at least 25, at least 26, at least 27, at least 28, at least 29, at least 30, at least 31, at least 32, at least 33, at least 34, at least 35, at least 36, at least 37, at least 38, at least 39, at least or 40. In some embodiments, the number of fenestrations is at most about 40, at most 39, at most 38, at most 37, at most 36, at most 35, at most 34, at most 33, at most 32, at most 31, at most 30, at most 29, at most 28, at most 27, at most 26, at most 25, at most 24, at most 23, at most 22, at most 21, at most 20, at most 19, at most 18, at most 17, at most 16, at most 15, at most 14, at most 13, at most 12, at most 11, at most 10, at most 9, at most 8, at most 7, at most 6, at most 5, at most 4, at most 3, at most 2, at most or 1.

In some embodiments, the at least one fenestration is connected to at least one groove overlying the tear meniscus at distance, intermediate, and near gazes. The at least one groove may be disposed radially or circumferentially on the contact lens. The at least one groove may be on the posterior surface of the contact lens. The at least one groove may be in fluid communication with the at least one fenestration. For example, the at least one groove may extend radially to the outer edge of the contact lens, in at least some cases from the at least one fenestration, such as to facilitate flow of tear fluid from adjacent the outer edge of the contact lens. Alternatively, or in combination, the at least one groove may extend from the at least one fenestration to a relatively more interior portion of the contact lens such as to facilitate flow of tear fluid to the lenticular volume(s) formed. The contact lens may have a plurality of grooves.

The at least one groove may be distributed over a length (i.e., a radius, diameter, or circumference) of the contact lens that is at least about 4 mm, at least 4.1 mm, at least 4.2 mm, at least 4.3 mm, at least 4.4 mm, at least 4.5 mm, at least 4.6 mm, at least 4.7 mm, at least 4.8 mm, at least 4.9 mm, at least 5 mm, at least 5.1 mm, at least 5.2 mm, at least 5.3 mm, at least 5.4 mm, at least 5.5 mm, at least 5.6 mm, at least 5.7 mm, at least 5.8 mm, at least 5.9 mm, at least 6.0 mm, at least 6.1 mm, at least 6.2 mm, at least 6.3 mm, at least 6.4 mm, at least 6.5 mm, at least 6.6 mm, at least 6.7 mm, at least 6.8 mm, at least 6.9 mm, at least 7 mm, at least 7.1 mm, at least 7.2 mm, at least 7.3 mm, at least 7.4 mm, at least 7.5 mm 7.6 mm, at least 7.7 mm, at least 7.8 mm, at least 7.9 mm, at least 8 mm, at least 8.1 mm, at least 8.2 mm, at least 8.3 mm, at least 8.4 mm, at least 8.5 mm, at least 8.6 mm, at least 8.7 mm, at least 8.8 mm, at least 8.9 mm, at least 9 mm, at least 9.5 mm, at least 10 mm, at least 10.5 mm, at least 11 mm, or any values therebetween. In some embodiments, the at least one groove may be at most about 11 mm, at most 10.5 mm, at most 10 mm, at most 9.5 mm, at most 9 mm, at most 8.9 mm, at most 8.8 mm, at most 8.7 mm, at most 8.6 mm, at most 8.5 mm, at most 8.4 mm, at most 8.3 mm, at most 8.2 mm, at most 8.1 mm, at most 8 mm, at most 7.9 mm, at most 7.8 mm, at most 7.7 mm, at most 7.6 mm, at most 7.5 mm, at most 7.4 mm, at most 7.3 mm, at most 7.2 mm, at most 7.1 mm, at most 7 mm, at most 6.9 mm, at most 6.8 mm, at most 6.7 mm, at most 6.6 mm, at most 6.5 mm, at most 6.4 mm, at most 6.3 mm, at most 6.2 mm, at most 6.1 mm, at most 6 mm, at most 5.9 mm, at most 5.8 mm, at most 5.7 mm, at most 5.6 mm, at most 5.5 mm, at most 5.4 mm, at most 5.3 mm, at most 5.2 mm, at most 5.1 mm, at most 5 mm, at most 4.9 mm, at most 4.8 mm, at most 4.7 mm, at most 4.6 mm, at most 4.5 mm, at most 4.4 mm, at most 4.3 mm, at most 4.2 mm, at most 4.1 mm, at most 4 mm, or any values therebetween. The at least one groove may be distributed over a length of the contact lens that may be within a range defined by any two of the preceding values. For instance, the at least one groove may be distributed over a length of the contact lens from about 4 mm to about 11 mm. In an example, the at least one groove may be distributed over a length from about 5.5 mm to about 10.5 mm.

### Resistance to Flow

In another aspect, the contact lenses described herein feature fenestrations with improved resistance to flow. The resistance to flow of the fenestrations depends on at least two factors: the cross-sectional area of the fenestration and the length (i.e., thickness of the contact lens) of the fenestration from the anterior surface of the contact lens (i.e., from the fluid source) to the posterior surface of the contact lens (i.e., to the lenticular volume). In some embodiments, a fenestration having a larger cross-sectional area has less resistance to flow relative to an otherwise similar fenestration having a smaller cross-sectional area. In some embodiments, a fenestration having a shorter length has less resistance to flow relative to an otherwise similar fenestration having a longer length. In some embodiments, less resistance to flow is an ease of flow of fluid through the fenestration. In some embodiments, a fenestration that provides less resistance to flow is able to transport the fluid from one surface to the opposite surface relatively easier than a fenestration that does not provide less resistance to flow.

In some embodiments, the thickness of the contact lens varies positionally. For example, in some embodiments, the central portion is thicker than peripheral portions of the contact lens. In some embodiments, fenestrations positioned centrally have longer lengths between the anterior and posterior surfaces to reduce the resistance to flow. In some embodiments, fenestrations positioned towards the periphery have shorter lengths between the anterior and posterior surfaces to reduce the resistance to flow. In some embodiments, the volume of a fluid disposed over the central portion of the contact lens is smaller than the volume of fluid disposed over peripheral portions of the contact lens. Thus, a balance should be struck between fenestration length and fluid volume by positioning the fenestrations a minimal distance away from the center of the contact lens.

The fenestration(s) may be positioned on any portion of the contact lens. The fenestration(s) may be at least about 3 millimeters (mm), at least 3.1 mm, at least 3.2 mm, at least 3.3 mm, at least 3.4 mm, at least 3.5 mm, at least 3.6 mm, at least 3.6 mm, at least 3.7 mm, at least 3.8 mm, at least 3.9 mm, at least 4 mm, at least 4.1 mm, at least 4.2 mm, at least 4.3 mm, at least 4.4 mm, at least 4.5 mm, at least 4.6 mm, at least 4.7 mm, at least 4.8 mm, at least 4.9 mm, at least 5 mm, at least 5.1 mm, at least 5.2 mm, at least 5.3 mm, at least 5.4 mm, at least 5.5 mm, at least 5.6 mm, at least 5.7 mm, at least 5.8 mm, at least 5.9 mm, at least 6.0 mm, at least 6.1 mm, at least 6.2 mm, at least 6.3 mm, at least 6.4 mm, at least 6.5 mm, at least 6.6 mm, at least 6.7 mm, at least 6.8 mm, at least 6.9 mm, at least 7 mm, at least 7.1 mm, at least 7.2 mm, at least 7.3 mm, at least 7.4 mm, at least 7.5 mm 7.6 mm, at least 7.7 mm, at least 7.8 mm, at least 7.9 mm, at least 8 mm, at least 8.1 mm, at least 8.2 mm, at least 8.3 mm, at least 8.4 mm, at least 8.5 mm, at least 8.6 mm, at least 8.7 mm, at least 8.8 mm, at least 8.9 mm, at least 9 mm, or more, away from the center of the contact lens. In some embodiments, the fenestration(s) may be at most about 9 mm, at most 8.9 mm, at most 8.8 mm, at most 8.7 mm, at most 8.6 mm, at most 8.5 mm, at most 8.4 mm, at most 8.3 mm, at most 8.2 mm, at most 8.1 mm, at most 8 mm, at most 7.9 mm, at most 7.8 mm, at most 7.7 mm, at most 7.6 mm, at most 7.5 mm, at most 7.4 mm, at most 7.3 mm, at most 7.2 mm, at most 7.1 mm, at most 7 mm, at most 6.9 mm, at most 6.8 mm, at most 6.7 mm, at most 6.6 mm, at most 6.5 mm, at most 6.4 mm, at most 6.3 mm, at most 6.2 mm, at most 6.1 mm, at most 6 mm, at most 5.9 mm, at most 5.8 mm, at most 5.7 mm, at most 5.6 mm, at most 5.5 mm, at most 5.4 mm, at most 5.3 mm, at most 5.2 mm, at most 5.1 mm, at most 5 mm, at most 4.9 mm, at most 4.8 mm, at most 4.7 mm, at most 4.6 mm, at most 4.5 mm, at most 4.4 mm, at most 4.3 mm, at most 4.2 mm, at most 4.1 mm, at most 4 mm, at most 3.9 mm, at most 3.8 mm 3.7 mm, at most 3.6 mm, at most 3.5 mm, at most 3.4 mm, at most 3.3 mm, at most 3.2 mm, at most 3.1 mm, at most 3 mm, or less, away from the center of the contact lens. The fenestration(s) may be located a distance away from the center of the contact lens that may be within a range defined by any two of the preceding values. For instance, the fenestration(s) may be located from about 3 mm to about 9 mm away from the center of the contact lens. In an example, the fenestrations may be from about 5 mm to about 8 mm away from the center of the contact lens.

In some embodiments, a fenestration is positioned about 4 mm to about 6 mm from the center of the lens. Because the IPF is typically about 10 mm during distance vision, positioning the fenestrations 5 mm+/−1 mm from the center of the lens (e.g., the fenestrations having a diameter of roughly about 8 mm to about 12 mm) may be preferred.

In some embodiments, the length 203 of either the circumferential fenestrations 201 or the length 303 of the radial fenestrations 303 is dependent on the thickness of the contact lens at a given position. For example, a contact lens may be thicker towards the center relative to a peripheral area, therefore, a fenestration will have a longer length when positioned towards the center in comparison to a fenestration positioned towards the periphery.

Either the circumferential fenestrations 201 or the radial fenestrations 301 may have a length 203, 303 of at least about 40 μm at least 50 μm, at least 60 μm, at least 70 μm, at least 80 μm, at least 90 μm, at least 100 microns, 150 μm, at least 200 μm, at least 250 μm, at least 300 μm, at least 350 μm, at least 400 μm, at least 450 μm, at least 500 μm, at least 550 μm, at least 600 μm, or any values therebetween. In some embodiments, either the circumferential fenestrations 201 or the radial fenestrations 301 may a length 203, 303 of at most about 600 μm, at most 550 μm, at most 500 μm, at most 450 μm, at most 400 μm, at most 350 μm, at most 300 μm, at most 250 μm, at most 200 μm, at most 150 μm, at most 100 μm, at most 90 μm, at most 80 μm, at most 70 μm, at most 60 μm, at most 50 μm, at most 40 μm, or any values therebetween. Either the circumferential fenestrations 201 or the radial fenestrations 301 may have a length 203, 303 that may be within a range defined by any two of the preceding values. For instance, either the circumferential fenestrations 201 or the radial fenestrations 301 may have a length 203, 303 from about 40 μm to about 600 μm. In an example, the fenestrations 201, 301 may have a length 203, 303 from about 300 μm to about 600 μm.

The fenestration(s) may have any cross-sectional geometry including square, rectangular, circular, semi-circular, curved, triangular, or any other geometrical shape. In some embodiments, a fenestration has a square cross-sectional geometry. In some embodiments, a fenestration has a rectangular cross-sectional geometry. In some embodiments, a fenestration has a circular cross-sectional geometry. In some embodiments, a fenestration has a semi-circular cross-sectional geometry. In some embodiments, a fenestration has a curved cross-sectional geometry. In some embodiments, a fenestration has a triangular cross-sectional geometry.

The fenestration(s) may have a cross-sectional area of at least about 0.0001 millimeters squared (“mm2”), at least 0.0003 mm2, at least 0.0006 mm2, at least 0.0009 mm2, at least 0.001 mm2, at least 0.002 mm2, at least 0.004 mm2, at least 0.006 mm2, at least 0.008 mm2, at least 0.01 mm2, at least 0.02 mm2, at least 0.04 mm2, at least 0.06 mm2, at least 0.08 mm2, at least 0.1 mm2, at least 0.2 mm2, at least 0.3 mm2, at least 0.4 mm2, at least 0.5 mm2, at least 0.6 mm2, at least 0.7 mm2, at least 0.8 mm2, at least 0.9 mm2, at least 1 mm2, or any values therebetween. In some embodiments, the fenestration(s) may have a cross-sectional area of at most about 1 mm2, at most 0.9 mm2, at most 0.0.8 mm2, at most 0.7 mm2, at most 0.6 mm2, at most 0.5 mm2, at most 0.4 mm2, at most 0.3 mm2, at most 0.2 mm2, at most 0.1 mm2, at most 0.08 mm2, at most 0.06 mm2, at most 0.04 mm2, at most 0.02 mm2, at most 0.01 mm2, at most 0.008 mm2, at most 0.006 mm2, at most 0.004 mm2, at most 0.002 mm2, at most 0.001 mm2, at most 0.0009 mm2, at most 0.0006 mm2, at most 0.0003 mm2, at most 0.0001 mm2, or any values therebetween. The fenestration(s) may have a cross-sectional area that may be within a range defined by any two of the preceding values. For instance, the fenestration(s) may have a cross-sectional area from about 0.0001 mm2 to about 1 mm2. In an example, the fenestration(s) may have a cross-sectional area from about 0.0025 mm2 to about 0.25 mm2.

In some embodiments, the fenestration(s) have a circular cross section (i.e., the fenestration(s) are cylindrical). In such embodiments, the cross-sectional area of the fenestration(s) can be approximated by the diameter 204 of the circumferential fenestrations 201 or the diameter 304 of the radial fenestrations 301. Generally, a fenestration with a larger diameter will have less resistance to fluid flow.

In some embodiments, the volumetric flow rate for a given fenestration may be approximated by the formula, Q=vA where Q is the volumetric flow rate (mm3/s), v is the flow velocity (mm/s), and A is the cross-sectional area (mm2) of the fenestration. For example, the volume required to mask astigmatism of 0.25D at a 2 mm diameter is roughly 2.0×10-4 microliters. For example, the volume required to mask astigmatism of 2.5D over a 4 mm diameter is roughly 5.0×10−2 microliters. For example, to fill a 5.0×10−2 microliter volume in less than 250 ms, the fenestration(s) may be able to achieve a volumetric flow rate (Q) of 2.0×10-1 mm3/s- assuming a single fenestration and a linear flow rate of 10 mm/s, the diameter should be 0.16 mm or larger.

The fenestration(s) may have a diameter of at least about 0.01 mm, at least 0.02 mm, at least 0.03 mm, at least 0.04 mm, at least 0.05 mm, at least 0.06 mm, at least 0.07 mm, at least 0.08 mm, at least 0.09 mm, at least 0.1 mm, at least 0.2 mm, at least 0.3 mm, at least 0.4 mm, at least 0.5 mm, at least 0.6 mm, at least 0.7 mm, at least 0.8 mm, at least 0.9 mm, at least 1 mm, or any values therebetween. In some embodiments, the fenestration(s) may have a diameter of at most about 1 mm, at most 0.9 mm, at most 0.8 mm, at most 0.7 mm, at most 0.6 mm, at most 0.5 mm, at most 0.4 mm, at most 0.3 mm, at most 0.2 mm, at most 0.1 mm, at most 0.09 mm, at most 0.08 mm, at most 0.07 mm, at most 0.06 mm, at most 0.5 mm, at most 0.04 mm, at most 0.03 mm, at most 0.02 mm, at most 0.01 mm, or any values therebetween. The fenestrations may have a diameter that may be within a range defined by any two of the preceding values. For instance, the fenestrations may have a diameter from about 0.05 mm to about 1 mm. In an example, the fenestrations may have a diameter from about 0.05 mm to about 0.5 mm.

The contact lenses of the present disclosure may have at least one fenestration. The contact lens may have at least about 1, 2, 3, 4, 5, 6, 7, 8, 9, 10, 11, 12, 13, 14, 15, 16, 17, 18, 19, 20, or more fenestration(s). In some embodiments, the contact lens may have at most about 20, 19, 18, 17, 16, 15, 14, 13, 12, 11, 10, 9, 8, 7, 6, 5, 4, 3, 2, or 1 fenestration(s).

### Lens Material Properties

### Chemical Properties

In some embodiments, the adhesion forces between the contact lens and the fluid (e.g., tear fluid or artificial tear fluid) as well as adhesion forces between the contact lens and the corneal surface determine the ease with which a fluid migrates from the anterior surface of the lens to the posterior surface. For example, weaker adhesion forces between a contact lens and the fluid and/or weaker adhesion forces between a contact lens the corneal surface allows for easier migration of the fluid through a fenestration on the contact lens. In some embodiments, adhesion forces can be controlled through modifying or specifically selecting the chemistry of the surface of the contact lens. For example, selecting a lens with a more hydrophilic surface or modifying the surface of a lens so that is it more hydrophilic will strengthen the adhesion forces. In some embodiments, selecting a lens with a less hydrophilic surface or modifying the surface of a lens so that is it less hydrophilic will weaken the adhesion forces.

In some embodiments, the adhesion forces cause the lens to adhere to the corneal surface while providing between about 0.1 mm to about 0.5 mm of contact lens movement (e.g., in any direction along the surface of the cornea) following a blink. In a preferred embodiment, the lens should adhere to the surface of the cornea while providing some lens movement following a blink as commonly desired in the art.

In some embodiments, soft contact lenses are made of polymers or hydrogels whose chemical properties are defined by their chemical composition. In some embodiments, the contact lenses are made of a single material. In some embodiments, the contact lens is made of a soft material. In some embodiments, the contact lenses is made of a single material that has substantially uniform mechanical properties throughout. In some embodiments, the contact lens is made of a single polymeric material. In some embodiments, the contact lenses comprises a hydrogel, silicone hydrogel, or silicone. In some embodiments, the contact lens is made from a single material comprising diacetone acrylamide, N,N-dimethylacrylamide, 2-hydroxyethyl methacrylate, methacrylic acid, methyl methacrylate, N-carboxyl vinyl ester, N-vinyl pyrrolidone, poly[dimethylsiloxyl]di[silybutanol]bis[vinyl carbamate], phosphorylcholine, tris-(trimethylsiloxysilyl) propylvinyl carbamate, tris-(hydroxylmethyl) aminomethane, siloxane, or polyvinylpyrrolidone. In some embodiments, the contact lenses comprises a hydrogel. In some embodiments, the contact lenses comprises a silicone hydrogel.

In some embodiments, the chemistry of the surface of the lens is modified through the application of coatings or other suitable means known in the art. In some embodiments, the surface of the lens may be modified by at least one of chemical treatment, chemical vapor deposition, chemical etching, gas plasma, or laser treatment.

### Mechanical Properties

In some embodiments, soft contact lenses are made of elastomeric or partially elastomeric materials. Such elasticity means that any deformation from a neutral configuration (i.e., “as-manufactured” shape) is caused by an external stress such as blinking. Such external stresses are energetically stored within the deformed lens and causes the lens to bias towards the neutral configuration when the external stresses are reduced or removed. In some embodiments, for a soft, spherical contact lens on an astigmatic cornea, the act of conforming the contact lens to the non-spherically symmetric (i.e., non-axially symmetric) surface (of the cornea) generates a small amount of potential energy stored within the lens. In some embodiments, the act of blinking causes the contact lens to fully conform to the non-spherically symmetric cornea. In some embodiments, the fully conformed contact lens retains a deformed shape (i.e., deformed from a neutral configuration) because of adhesive energy between the surface of the lens and the corneal surface (if, for example, the adhesive energy is greater than the stored potential energy in the fully conformed contact lens). In some embodiments, the stored energy causes the lens to partially vault from the cornea in a process that returns the contact lens closer to its lowest energy configuration (i.e., neutral configuration or “as-manufacture” shape). In some embodiments, as the contact lens partially vaults, fluid flows into the space formed between the corneal surface and the posterior surface of the lens structurally supporting the contact lens. In some embodiments, the greater the potential energy stored within the lens body, the easier it is for the lens body to deviate from a deformed configuration (i.e., return to a neutral configuration) and a fluid to flow between the posterior surface of the lens and the corneal surface.

In some embodiments, the contact lenses of the present disclosure further comprises at least one groove to facilitate fluid flow. In some embodiments, the lens includes at least one fenestration and at least one groove acting as a fluid pathway between a fluid source and a lenticular volume formed between a posterior surface of the lens and a corneal surface of the eye. For example, the at least one grove may act as a fluid pathway from the tear meniscus to the fenestrations or lenticular volume. In some embodiments, the at least one groove further reduces the resistance of flow of the fluid, allowing the fluid to flow more quickly into the lenticular volume. In some embodiments, the at least one groove is a plurality of grooves. In some embodiments, he grooves are distributed radially, circumferentially, or a combination thereof.

In some embodiments, the elastic modulus of the lens, thickness of the lens, and/or degree of deformation influences how much energy is stored in the lens when the lens conforms to the corneal surface. For example, a relatively thick lens can store greater energy when conformed to the corneal surface. In some embodiments, the degree of deformation is determined by measuring the volumetric difference between the lens's neutral configuration (i.e., “as-manufactured” shape) and the deformed configuration.

In some embodiments, the elastic modulus of the contact lens may be at least about 0.1 megapascals (MPa), at least 0.2 MPa, at least 0.3 MPa, at least 0.4 MPa, at least 0.5 MPa, at least 0.6 MPa, at least 0.7 MPa, at least 0.8 MPa, at least 0.9 MPa, at least 1 MPa, at least 1.1 MPa, at least 1.2 MPa, at least 1.3 MPa, at least 1.4 MPa, at least 1.5 MPa, at least 1.6 MPa, at least 1.7 MPa, at least 1.8 MPa, at least 1.9 MPa, at least 2 MPa, at least 2.1 MPa, at least 2.2 MPa, at least 2.3 MPa, at least 2.4 MPa, at least 2.5 MPa, at least 2.6 MPa, at least 2.7 MPa, at least 2.8 MPa, at least 2.9 MPa, at least 3 MPa, at least 4 MPa, at least 5 MPa, at least 6 MPa, at least 7 MPa, at least 8 MPa, at least 9 MPa, at least 10 MPa, or more. In some embodiments, the elastic modulus of the contact lens may be at most about 10 MPa, at most 9 MPa, at most 8 MPa, at most 7 MPa, at most 6 MPa, at most 5 MPa, at most 4 MPa, at most 3 MPa, at most 2.9 MPa, at most 2.8 MPa, at most 2.7 MPa, at most 2.6 MPa, at most 2.5 MPa, at most 2.4 MPa, at most 2.3 MPa, at most 2.2 MPa, at most 2.1 MPa, at most 2 MPa, at most 1.9 MPa, at most 1.8 MPa, at most 1.7 MPa, at most 1.6 MPa, at most 1.5 MPa, at most 1.4 MPa, at most 1.3 MPa, at most 1.2 MPa, at most 1.1 MPa, at most 1 MPa, at most 0.9 MPa, at most 0.8 MPa, at most 0.7 MPa, at most 0.6 MPa, at most 0.5 MPa, at most 0.4 MPa, at most 0.3 MPa, at most 0.2 MPa, at most 0.1 MPa, or less. The elastic modulus of the contact lens may be within a range defined by any two of the preceding values. For instance, the elastic modulus of the contact lens may be from about 0.1 MPa to about 10 MPa. For example, the elastic modulus of the contact lens may be from about 0.1 MPa to about 4 MPa.

In some embodiments, the contact lens comprises a material having a rigidity range from about 1.25E+04 MPa*μm³ to about 5.00E+08 MPa*μm³.

In some embodiments, the mechanical properties of any feature of the lenses described herein, depend on both the geometry of feature and the material of the feature (including the material's properties). Aspects of the mechanical properties of the lens body are described using the mechanical model of a simply supported circular plate. In this model, the deflection of the simply supported plate (“D”) is proportional to the Young's modulus (“E”) multiplied by the thickness (“t”) cubed or D=Et3/(12*(1−v2). Other parameters of the model (such as, radius of plate, uniform loading, and Poisson's ratio (“v”)) may be treated as constants when comparing various modulus and thickness configurations. When comparing the lenses of the present disclosure, the current description utilizes unit's customary to contact lens designers of Megapascals (“MPa”) for Young's Modulus and micrometers (“um”) for thickness.

In some embodiments, the thickness of the contact lens may be at least about 40 μm, at least 50 μm, at least 60 μm, at least 70 μm, at least 80 μm, at least 90 μm, at least 100 microns, 150 μm, at least 200 μm, at least 250 μm, at least 300 μm, at least 350 μm, at least 400 μm, at least 450 μm, at least 500 μm, at least 550 μm, at least 600 μm, at least 650 μm, at least 700 μm, at least 750 μm, or any values therebetween. In some embodiments, the thickness of the contact lens may be at most about 800 μm, at most 750 μm, at most 700 μm, at most 650 μm, at most 600 μm, at most 550 μm, at most 500 μm, at most 450 μm, at most 400 μm, at most 350 μm, at most 300 μm, at most 250 μm, at most 200 μm, at most 150 μm, at most 100 μm, at most 90 μm, at most 80 μm, at most 70 μm, at most 60 μm, at most 50 μm, at most 40 μm, or any values therebetween. The thickness of the contact lens may be within a range defined by any two of the preceding values. For instance, the thickness of the contact lens may be from about 40 μm to about 600 μm. For example, the thickness of the contact lens may be from about 300 μm to about 600 μm. In some embodiments, the thickness of a fenestration at a position on the contact lens is the thickness of the contact lens at the same position.

### Lens Geometry

In some embodiments, the greater the discrepancy between the “as-manufactured” contact lens curvature and corneal curvature (i.e., the curvature of the corneal surface), the greater the energy that will be stored in the lens when conforming to the corneal surface during blinking. In some embodiments, the higher the potential energy stored in the lens upon deformation, the greater the ability of the lens to return to the neutral (i.e., “as-manufactured” shape). In some embodiments, the closer the lens is to its as-manufactured shape when disposed over the corneal surface, the greater the ability of the lens to facilitate fluid flow to the lenticular volume. In some embodiments, a contact lens with greater disparity between the “as-manufactured” curvature and corneal curvature has more energy to draw fluid from the tear meniscus to provide corrective power.

In some embodiments, the “as-manufactured” contact lens has at least some portions that are flatter than the steep regions of the cornea (i.e., the curvature of portions of the lens are less than the corneal curvature), to enable fluid movement. In some embodiments, the “as-manufactured” contact lens has at least some portions that substantially conform to the flat regions of the cornea (i.e., the curvature of portions of the lens is equal to the corneal curvature) to stabilize the contact lens and dictate the average curvature of the lens. In some embodiments, the contact lens has an average curvature that is equal to less than (i.e., flatter than) the corneal curvature.

In some embodiments, the contact lens has an average curvature of at least about 5 mm, at least 5.5 mm, at least 6 mm, at least 6.5 mm, at least 7 mm, at least 7.5 mm, at least 8 mm, at least 8.5 mm, at least 9 mm, at least 9.5 mm, at least 10 mm, at least 10.5 mm, at least 11 mm, at least 11.5 mm, at least 12 mm, at least 12.5 mm, or any values therebetween. In some embodiments, the contact lens has an average curvature of at most about 12.5 mm, at most 12 mm, at most 11.5 mm, at most 11 mm, at most 10.5 mm, at most 10 mm, at most 9.5 mm, at most 9 mm, at most 8.5 mm, at most 8 mm, at most 7.5 mm, at most 7 mm, at most 6.5 mm, at most 6 mm, at most 5.5 mm, at most 5 mm, or any values therebetween. The contact lens may have an average curvature that may be within a range defined by any two of the preceding values. For instance, the contact lens may have an average curvature from about 5 mm to about 12.5 mm. In an example, the contact lens may have an average curvature from about 6.5 mm to about 9.5 mm.

In some embodiments, the contact lens is axially symmetric (i.e., axisymmetric). In some embodiments, the anterior surface of the contact lens is axisymmetric.

In some embodiments, the contact lens comprises at least one fenestration that is positioned adjacent to the tear meniscus to promote flow of tear fluid to the lenticular volume. In some embodiments, the contact lens does not have a toric element (e.g., prism ballast, dynamic stabilization, peri-ballast, truncation) to rotationally orient the contact lens. In some embodiments, the contact lens comprises a toric element (e.g., prism ballast, dynamic stabilization, peri-ballast, truncation) to rotationally orient the contact lens. In some embodiments, a toric element is used for aligning the at least one fenestration with the tear meniscus. In some embodiments, a toric element does not require customization related to the orientation of the corneal topography and/or astigmatism.

### Methods

Described herein are methods for forming a tear lens for masking or correcting an optical aberration of the eye. In some embodiments, the methods comprise the step of placing, applying, or positioning a contact lens having a soft lens body and at least one fenestration over a corneal surface of the eye so that a portion of a posterior surface of the soft lens body of the contact lens (i.e., a conforming portion) substantially conforms to a relatively flat region of the corneal surface to support another portion of the posterior surface which vaults over a relatively steeper area of the corneal surface (i.e. a vaulted portion). In some embodiments, the vaulted portion forms a lenticular volume between a relatively steep region of the cornea and the posterior surface of the soft lens body of the contact lens. In some embodiments, the at least one fenestration promotes or facilitates flow of a tear fluid to fill the lenticular volume with the tear fluid thereby forming a tear lens.

In some embodiments, the tear lens is configured to at least partially correct the optical aberration of the eye. In some embodiments, the tear lens is configured to at least partially correct the astigmatism of the eye.

In some embodiments, the lens is applied over the corneal surface of the eye so that the at least one fenestration is positioned adjacent one or more of an upper, lower, or lateral tear meniscus of the eye to enhance tear flow therefrom through the at least one fenestration and into the lenticular volume. In some embodiments, the at least one fenestration is positioned on the contact lens such that the at least one fenestration is placed adjacent one or more tear menisci irrespective of the rotational orientation of the contact lens as applied over the corneal surface of the eye.

In some embodiments, the tear lens is configured to mask an astigmatism of an eye of a subject. In some embodiments, the tear lens may be configured to mask astigmatism up to about 2.5 diopters (D). In some embodiments, the tear lens is configured to mask astigmatism up to about 5 D, up to 4.75 D, up to 4.5 D, up to 4.25 D, up to 4 D, up to 3.75 D, up to 3.5 D, up to 3.25 D, up to 3 D, up to 2.75 D, up to 2.5 D, up to 2.25 D, up to 2.0 D, up to 1.75 D, up to 1.5 D, up to 1 D, up to 0.7 D, up to 0.5 D, or less. In some embodiments, the tear lens is configured to mask astigmatism of at least about 0.5 D, at least 0.7 D, at least 1 D, at least 1.5 D, at least 1.75 D, at least 2.0 D, at least 2.25 D, at least 2.5 D, at least 2.75 D, at least 3 D, at least 3.25 D, at least 3.5 D, at least 3.75 D, at least 4 D, at least 4.25 D, at least 4.5 D, at least 4.75 D, at least 5 D, or more. In some embodiments, the tear lens is configured to mask an astigmatism that is within a range defined by any two of the preceding values. In some embodiments, the astigmatism is within a range from about 2.25 D to about 2.5 D. In some embodiments, the tear lens is configured to mask an astigmatism in increments of 0.01 D due to the sensitivity of the tear lens formation and is not limited to 0.25D increments as is customary in standard toric lens. In some cases, the tear lens may be configured to mask astigmatism up to about 5 D, up to 4.9 D, up to 4.8 D, up to 4.7 D, up to 4.6 D, up to 4.5 D, up to 4.4 D, up to 4.3 D, up to 4.2 D, up to 4.1 D, up to 4 D, up to 3.9 D, up to 3.8 D, up to 3.7 D, up to 3.6 D, up to 3.5 D, up to 3.4 D, up to 3.3 D, up to 3.2 D, up to 3.1 D, up to 3 D, up to 2.9 D, up to 2.8 D, up to 2.7 D, up to 2.6 D, up to 2.5 D, up to 2.4 D, up to 2.3 D, up to 2.2 D, up to 2.1 D, up to 2.0, up to 1.9 D, up to 1.8 D, up to 1.7 D, up to 1.6 D, up to 1.5 D, up to 1.4 D, up to 1.3 D, up to 1.2 D, up to 1 D, up to 0.9 D, up to 0.8 D, up to 0.7 D, up to 0.6 D, up to 0.5 D, up to 0.4 D, up to 0.3 D, up to 0.2 D, up to 0.1 D, or less. In some embodiments, the tear lens is configured to mask astigmatism of at least about 0.1 D, at least 0.2 D, at least 0.3 D, at least 0.4 D, at least 0.5 D, at least 0.6 D, at least 0.7 D, at least 0.8 D, at least 0.9 D, at least 1 D, at least 1.1 D, at least 1.2 D, at least 1.3 D, at least 1.4 D, at least 1.5 D, at least 1.6 D, at least 1.7 D, at least 1.8 D, at least 1.9 D, at least 2 D, at least 2.1 D, at least 2.2 D, at least 2.3 D, at least 2.4 D, at least 2.5 D, at least 2.6 D, at least 2.7 D, at least 2.8 D, at least 2.9 D, at least 3 D, at least 3.1 D, at least 3.2 D, at least 3.3 D, at least 3.4 D, at least 3.5 D, at least 3.6 D, at least 3.7 D, at least 3.8 D, at least 3.9 D, at least 4 D, at least 4.1 D, at least 4.2 D 4.3 D, at least 4.4 D, at least 4.5 D, at least 4.6 D, at least 4.7 D, at least 4.8, at least 4.9 D, at least 5 D, or more.

In some embodiments, the contact lens is configured such that only the spherical power of the lens is required to correct the vision of a subject in need thereof, to their best corrected visual acuity. In some embodiments, the contact lens is configured to mask an astigmatism such that only the spherical power of the lens is required to correct the vision of a subject in need thereof, to a visual acuity.

In some embodiments, the tear lens is configured to correct for meridian angles of about 10 degrees to about 1 degree. In some embodiments, the tear lens is configured to correct meridian angels up to about 10 degrees, up to 9 degrees, up to 8 degrees, up to 7 degrees, up to 6 degrees, up to 5 degrees, up to 4 degrees, up to 3 degrees, up to 2 degrees, up to 1 degree, or less. In some cases, the covering 120 may be configured to correct for meridian angles of at least about 1 degree, at least 2 degrees, at least 3 degrees, at least 4 degrees, at least 5 degrees, at least 6 degrees, at least 7 degrees, at least 8 degrees, at least 9 degrees, at least 10 degrees, or more. The tear lens may be configured to correct meridian angle that is within a range defined by any two of the preceding values. In some embodiments, the meridian angle can be within a range from about 3 to about 4 degrees.

In some embodiments, the tear lens is configured to correct for differences in corneal power between meridians of about 3 D to about 0 D. In some embodiments, the tear lens is configured to correct for differences in corneal power up to about 3 D, up to 2.9 D, up to 2.8 D, up to 2.7 D, up to 2.6 D, up to 2.5 D, up to 2.4 D, up to 2.3 D, up to 2.2 D, up to 2.1 D, up to 2 D, up to 1.9 D, up to 1.8 D, up to 1.7 D, up to 1.6 D, up to 1.5 D, up to 1.4 D, up to 1.3 D, up to 1.2D, up to 1 D, up to 0.9 D, up to 0.8 D, up to 0.7 D, up to 0.6 D, up to 0.5 D, up to 0.4 D, up to 0.3 D, up to 0.2 D, up to 0.1 D, or less. In some examples, the tear lens may be configured to correct for differences in corneal power of at least about 0.1 D, at least 0.2 D, at least 0.3 D, at least 0.4 D, at least 0.5 D, at least 0.6 D, at least 0.7 D, at least 0.8 D, at least 0.9 D, at least 1 D, at least 1.1 D, at least 1.2 D, at least 1.3 D, at least 1.4 D, at least 1.5 D, at least 1.6 D, at least 1.7 D, at least 1.8 D, at least 1.9 D, at least 2 D, at least 2.1 D, at least 2.2 D, at least 2.3 D, at least 2.4 D 2.5 D, at least 2.6 D, at least 2.7 D, at least 2.8 D, at least 2.9 D, at least 3 D, or more. The tear lens may be configured to correct for differences in corneal power that is within a range defined by any two of the preceding values. In some embodiments, the difference in corneal power is within a range from about 0.5 D and about 2.5 D.

### Examples

The embodiments of the present disclosure now being generally described, it will more readily be understood to by reference to the following examples which are included merely for the purpose of illustration of certain aspects and embodiments of the present disclosure and are not intended to limit the scope of the present disclosure in any way.

### Example 1: Pupil to Eyelid Measurements

In the many embodiments described here, fenestration(s), groove(s), and/or other tear fluid channels can be optimally positioned to promote or facilitate flow of tear fluid to the lenticular volume(s) formed when the herein described soft, tear lens forming contact lens is applied over an eye with its eyelid open. To optimally position such features on a contact lens, lens manufacturers should well understand the anatomy of the eye. While eye anatomy and relative dimensions are well-known in the scientific and medical literature, the inventors have undertaken experiments to validate such knowledge as well. Table 1 shows experimental pupil to eye lid measurements made by the inventors herein. Table 2 shows pupil to eye lid measurements extrapolated from Bosch et al., 1999 (Topographic anatomy of the eyelids, and the effects of sex and age; W A van den Bosch, I. Leenders, P Mulder; Br J Opthalmol.; 1999 March; 83(3):347-52; doi: 10.1136/bjo.83.3.347). In both studies, the pupil-lower lid distance (PLD) measurements and intra palpebral distance (IPD) measurements were not significantly different and may be considered consistent with one another. Hence, eye anatomy measurements from both the scientific and medical literature and independent studies may be relied upon as conditions for lens design in accordance with embodiments described herein.

TABLE 1

| | PD | PLD | IPD |
|---|---|---|---|
| | Pupil | Pupil-lower | Intra Palpebral |
| | diameter | lid distance | Distance |
| Average | 2.45 | 5.32 | 9.53 |
| STDEV | 0.41 | 0.89 | 1.46 |
| 95% of eyes min | | 3.54 | 6.60 |
| 95% of eyes max | | 7.09 | 12.46 |

TABLE 2

| | | |
|---|---|---|
| PD | PLD | IPD |
| Pupil | Pupil-lower | Intra Palpebral |
| diameter | lid distance | Distance |

| | | |
|---|---|---|
| Average | 5.5 | 9.2 |
| STDEV | 1 | 1.25 |
| 95% of eyes min | 3.50 | 6.70 |
| 95% of eyes max | 7.50 | 11.70 |

### Example 2: Lens Fitting

The inventors also tested contact lenses to evaluate how much fitting would be required for particular subject. Subjects having a wide range of corneal curvatures ranging from 7.2 mm to 8 mm in the central 3 mm of the cornea and varying degrees of astigmatism ranging from about 0.75 D to about 3.5 D tested. These subjects provided contact lenses having a non-optimized base curvature of 7.86 mm. Surprisingly, the contact lenses with the non-optimized, generic base curve of 7.86 mm was able to reduce between 0.75-1.5 D of astigmatism in all of the subjects. Hence, minimal fitting, if any at all, may be required to provide a proper fitting lens for the majority of the population who may be in need of masking astigmatism and other optical aberrations.

### Example 3: Testing of Fenestration Positioning

The inventors have also undertaken experiments to apply contact lenses manufactured in accordance with embodiments described herein to test subjects with astigmatism. Seven subjects with astigmatism, ranging from 0.75 D to 2.5D, were tested and each subject was tested with two versions of contact lenses. These two versions of contact lenses had the same material and geometry, namely being made of a silicone hydrogel available as Unisil from Contamac US of Grand Junction, CO, having a base curve of 7.87 mm, having a diameter of 14.5 mm, having 8 radial grooves, and having 8 fenestrations, each with a radius of 300 μm. The only difference between the two versions of the contact lenses was fenestration placement either 3.0 mm from the center of the lens or 6.6 mm from the center of the lens, which would be closer to a tear meniscus of the eyes of the subjects. Both versions of the contact lenses reduced astigmatism, though the contact lenses with the fenestration placement closer to the tear meniscus was found to be more effective. In particular, the 3.0 mm from center fenestration lenses reduced astigmatism by an average of 0.67 D while the 6.6 mm from center fenestration lenses reduced astigmatism by an average of 1.04 D. The experiment therefore supports the theory of the inventors that closer positioning of the contact lens fenestrations to tear menisci can result in improved astigmatism reduction.

### Example 4: Configuration of Fenestrations on a Lens with Fixed Orientation

Provided herein is an exemplary contact lens having a toric element and fenestrations. Often, a toric element on a lens is utilized to position the lens in a particular orientation when disposed on the eye. The ability of a toric element to orient a lens into a specific position can be leveraged to when preparing a lens with fenestrations such that at least one fenestration is in constant contact with a tear meniscus (e.g., upper or lower tear meniscus). In some cases, the fenestrations can be designed to be radially distributed such that at least one fenestration is in constant contact with the tear meniscus.

Provided herein is a contact lens having a toric element (e.g., stabilizer or weight), where the lens is positioned such that the toric element is oriented downward (e.g., 6 o'clock orientation and/or towards the lower tear meniscus when worn on the eye) with fixed orientation in in the downward orientation (e.g., no rotation of the lens). The contact lens comprises two fenestrations, a first fenestration positioned downward and a second fenestration located 180 degrees apart from the first fenestration (e.g., 12 o'clock orientation) and positioned about a distance closer than the first fenestration from the center of the lens. In some cases, the contact lens comprises two fenestrations, a first fenestration positioned downward about 5 mm from the center of the lens and a second fenestration located 180 degrees apart from the first fenestration (e.g., 12 o'clock orientation) and positioned about 3.5 mm from the center of the lens. When worn on the eye by the user, at least one of the fenestrations is adjacent to a tear meniscus (e.g., upper or lower tear meniscus). In some cases, the distances of the fenestrations are chosen such that at least one fenestration is in continuous contact with a tear meniscus by considering the fixed orientation of the lens when worn on the eye by the user and/or a probable location of the tear meniscus on the eye.

### Example 5: Configuration of Fenestrations on a Lens with Free 180 Degrees Orientation

Provided herein is an exemplary contact lens having a toric element (e.g., stabilizer or weight) that can be positioned downward (e.g., 6 o'clock orientation and/or towards the lower tear meniscus when worn on the eye) or upwards (e.g., 12 o'clock orientation and/or towards the upper tear meniscus). Such lens may rotate freely in a 180-degree orientation so that the toric element is located either downward or upward orientation. In some cases, the lens is oriented with the toric element towards the upper or lower tear meniscus. The contact lens comprises four fenestrations, where two fenestrations are positioned downward and another two fenestrations are positioned upward. The two fenestrations pointing upward are located in a line from the center of the lens, one fenestration closer to the center of the lens than the other fenestration. The two fenestrations pointing downward are located in a line from the center of the lens, one fenestration closer to the center of the lens than the other fenestration. In some cases, the fenestrations form a line with two fenestrations distanced symmetrically from the center at a first distance and two fenestrations distanced symmetrically from the center at a second distance farther away from the center than the first distance. In some cases, a first fenestration is positioned about 3.5 mm from the center of the lens and a second fenestration is positioned about 5 mm from the center of the lens in the downward or upward orientation. In some cases, the distances of the fenestrations are chosen such that at least one fenestration is in continuous contact with a tear meniscus by considering the capability of the lens to rotate freely in 180 degrees when worn on the eye by the user and/or a probable location of the tear meniscus on the eye.

### Example 6: Configuration of Fenestrations on a Lens with Free Orientation

Provided herein is an exemplary contact lens having fenestrations with no toric element (e.g., stabilizer or weight), such that the lens is able to rotate freely when worn on the eye (e.g., free rotation). The contact lens comprises four fenestrations, where two fenestrations are positioned in a first radial line and another two fenestrations are positioned in a second radial line that is at about 90 degrees from the first radial line. In some cases, the first radial line is oriented upward (e.g., 12 o'clock orientation). In some cases, the second line is oriented at 3 o'clock orientation. In some cases, the second line is oriented at 9 o'clock orientation. The two fenestrations in the first radial line are located in a line from the center of the lens, one fenestration closer to the center of the lens than the other fenestration. The two fenestrations in the second radial line are located in a line from the center of the lens, one fenestration closer to the center of the lens than the other fenestration. In some cases, one fenestration in both first and second radial lines are distanced from the center at a first distance and the second fenestration in both first and second radial lines are at a second distance farther away from the center than the first distance. In some cases, a fenestration is positioned about 3.5 mm from the center of the lens and the second fenestration is positioned about 5 mm from the center of the lens. In some cases, the distances of the fenestrations are chosen such that at least one fenestration is in continuous contact with a tear meniscus by considering the capability of the lens to rotate when worn on the eye by the user and/or a probable location of the tear meniscus on the eye.

While preferred embodiments of the present disclosure have been shown and described herein, it will be obvious to those skilled in the art that such embodiments are provided by way of example only. It is not intended that the disclosure be limited by the specific examples provided within the specification. While the disclosure has been described with reference to the aforementioned specification, the descriptions and illustrations of the embodiments herein are not meant to be construed in a limiting sense. Numerous variations, changes, and substitutions will now occur to those skilled in the art without departing from the disclosure. Furthermore, it shall be understood that all aspects of the disclosure are not limited to the specific depictions, configurations or relative proportions set forth herein which depend upon a variety of conditions and variables. It should be understood that various alternatives to the embodiments of the disclosure described herein may be employed in practicing the disclosure. It is therefore contemplated that the present disclosure shall also cover any such alternatives, modifications, variations or equivalents. It is intended that the following claims define the scope of the disclosure and that methods and structures within the scope of these claims and their equivalents be covered thereby.

What is claimed is:

1. A contact lens for correcting vision of an eye of a subject, the contact lens comprising:
a soft lens body having an anterior surface, a posterior surface, and at least one fenestration traversing between the anterior surface and the posterior surface;
wherein the posterior surface of the lens body is configured to form, when applied over a corneal surface of the eye with an eyelid of the eye open, a conforming portion substantially conforming to a relatively flat region of the corneal surface and a vaulted portion forming a lenticular volume between a relatively steep region of the corneal surface and the posterior surface of the lens body;
wherein the at least one fenestration is configured to be positioned adjacent to a tear meniscus when the lens body is applied over the corneal surface with the eyelid of the eye open.

2. The contact lens of claim 1, wherein the at least one fenestration is configured to be positioned adjacent to the tear meniscus to promote flow of tear fluid therefrom to the lenticular volume, forming a tear lens, when the lens body is applied over the corneal surface with the eyelid of the eye open.

3. The contact lens of claim 2, wherein the tear lens is configured to at least partially correct an astigmatism of the eye.

4. The contact lens of claim 2 or 3, wherein the tear lens is configured to at least partially correct an optical aberration of the eye.

5. The contact lens of any one of claims 1 to 4, wherein the at least one fenestration has a geometry configured to promote the flow of the tear fluid from the tear meniscus to the lenticular volume.

6. The contact lens of any one of claims 1 to 5, wherein the at least one fenestration is configured to be positioned adjacent the tear meniscus to promote flow of tear fluid therefrom to the lenticular volume from adjacent the anterior surface of the lens body to the posterior surface of the lens body and to the lenticular volume.

7. The contact lens of any one of claims 1 to 6, wherein the tear meniscus is one or more of an upper meniscus or a lower meniscus of the eye of the subject.

8. The contact lens of any one of claims 1 to 7, wherein the at least one fenestration is configured to be positioned adjacent to the tear meniscus to promote flow of tear fluid to the lenticular volume irrespective of an orientation of the lens body to the tear meniscus, when the lens body is applied over the corneal surface with the eyelid of the eye open.

9. The contact lens of any one of claims 1 to 8, wherein the at least one fenestration is configured to be positioned adjacent to the tear meniscus to promote flow of tear fluid to the lenticular volume.

10. The contact lens of any one of claims 1 to 9, wherein the contact lens does not comprise a rotational orientation feature.

11. The contact lens of claim 10, wherein the rotation orientation feature comprises a prism ballast or a stabilizing dynamic element.

12. The contact lens of any one of claims 1 to 11, wherein the at least one fenestration is configured such that one fenestration of the at least one fenestration is constantly adjacent to the tear meniscus during wear.

13. The contact lens of any one of claims 1 to 12, wherein the contact lens comprises a rotational orientation feature.

14. The contact lens of claim 13, wherein the rotation orientation feature comprises a prism ballast or a stabilizing dynamic element.

15. The contact lens of claim 13 or 14, wherein the rotation orientation feature is not customized to a corneal topography or astigmatism.

16. The contact lens of any one of claims 1 to 15, wherein the at least one fenestration is configured to be positioned adjacent to the tear meniscus at a distance from about 0.0 mm to about 4 mm away, when the lens body is applied over the corneal surface with the eyelid of the eye open.

17. The contact lens of any one of claims 1 to 16, wherein the at least one fenestration is positioned from about 3 mm to about 9 mm from a center of the lens body.

18. The contact lens of claim 17, wherein the at least one fenestration is positioned from about 5 mm to about 8 mm from the center of the lens body.

19. The contact lens of any one of claims 1 to 18, wherein the at least one fenestration comprises a plurality of fenestrations.

20. The contact lens of claim 19, wherein the plurality of fenestration is evenly distributed around the center of the soft lens body.

21. The contact lens of claim 19, wherein the plurality of fenestrations is distributed non-evenly around the center of the soft lens body.

22. The contact lens of any one of claims 19 to 21, wherein the plurality of fenestrations is distributed circumferentially.

23. The contact lens of any one of claims 19 to 21, wherein the plurality of fenestrations is distributed radially.

24. The contact lens of claim 23, wherein adjacent fenestrations are separate from one another by a distance of about 1 mm.

25. The contact lens of claim 23 or 24, wherein the plurality of fenestrations is distributed along at least one meridian of the soft lens body.

26. The contact lens of any one of claims 23 to 24, wherein a radius defined by the plurality of fenestrations distributed radially is from about 3 mm to about 8 mm.

27. The contact lens of any one of claims 19 to 26, wherein the plurality of fenestrations is positioned from about 3 mm to about 9 mm from the center of the soft lens body.

28. The contact lens of any one of claims 19 to 27, wherein the plurality of fenestrations is distributed along a length of the soft lens body.

29. The contact lens of any one of claims 1 to 28, wherein the at least one fenestration of the plurality of fenestrations is constantly positioned adjacent to the tear meniscus.

30. The contact lens of any one of claims 19 to 28, wherein the length of the soft lens body is a radius, diameter, or circumference of the lens body.

31. The contact lens of claim 30, wherein the length of the soft lens body is from about 4 mm to about 45 mm.

32. The contact lens of any one of claims 1 to 31, wherein a length of the at least one fenestration from the anterior surface to the posterior surface is from about 40 μm to about 600 μm.

33. The contact lens of any one of claims 1 to 32, wherein the at least one fenestration has a cross-sectional area from about 0.0001 mm² to about 1 mm².

34. The contact lens of any one of claims 1 to 33, wherein the at least one fenestration has a cross-sectional area that is circular in shape.

35. The contact lens of any one of claims 1 to 34, wherein the at least one fenestration comprises from 1 to 25 fenestrations.

36. The contact lens of any one of claims 1 to 35, wherein the soft lens body is made of a soft material.

37. A method of correcting vision of an eye of a subject, the method comprising applying the contact lens of any one of claims 1 to 36 over the corneal surface of the eye of the subject with the eyelid of said eye open.

38. A method for correcting vision of an eye of a subject, the method comprising: identifying a subject in need of vision correction, including masking of astigmatism or an optical aberration of an eye of the subject; and
providing, to the subject, the contact lens of any one of claims 1 to 34 with minimal need for fitting of a base curve of the contact lens to a base curve of a cornea of the eye of the subject.

39. The method of claim 38, wherein the contact lens is provided to the subject with no fitting of the base curve of the contact lens to the eye of the subject.

40. A method for correction vision of an eye of a subject, the method comprising:
applying a contact lens having a soft lens body and at least one fenestration over a corneal surface of the eye of the subject with an eyelid of said eye open so that the posterior surface of the lens body forms a conforming portion substantially conforming to a relatively flat region of the corneal surface and a vaulted portion forming a lenticular volume between a relatively steep region of the cornea and the posterior surface of the lens body, wherein the at least one fenestration is positioned adjacent to a tear meniscus.

41. The method of claim 40, wherein the at least one fenestration is positioned adjacent to the tear meniscus to promote flow of tear fluid therefrom to the lenticular volume, forming a tear lens.

42. The method of claim 41, wherein the tear lens is configured to at least partially correct an astigmatism of the eye.

43. The method of claim 41 or 42, wherein the tear lens is configured to at least partially correct an optical aberration of the eye.

44. The method of any one of claims 40 to 43, wherein the at least one fenestration has a geometry configured to promote the flow of the tear fluid from the tear meniscus to the lenticular volume.

45. The method of any one of claims 40 to 44, wherein the at least one fenestration positioned adjacent the tear meniscus to promote flow of tear fluid therefrom to the lenticular volume from adjacent the anterior surface of the lens body to the posterior surface of the lens body and to the lenticular volume.

46. The method of any one of claims 40 to 45, wherein the tear meniscus is one or more of an upper meniscus or a lower meniscus of the eye of the subject.

47. The method of any one of claims 40 to 46, wherein the at least one fenestration is positioned adjacent to the tear meniscus to promote flow of tear fluid therefrom to the lenticular volume irrespective of an orientation of the lens body to the tear meniscus, when the lens body is applied over the corneal surface with the eyelid of the eye open.

48. The method of any one of claims 40 to 47, wherein the at least one fenestration is configured to be positioned adjacent to the tear meniscus at a distance from about 0.0 mm to about 4 mm away, when the lens body is applied over the corneal surface with the eyelid of the eye open.

49. The method of any one of claims 40 to 48, wherein the at least one fenestration is positioned from about 3 mm to about 9 mm from a center of the lens body.

50. The method of claim 49, wherein the at least one fenestration is positioned from about 5 mm to about 8 mm from the center of the lens body.

51. The method of any one of claims 40 to 50, wherein the at least one fenestration comprises a plurality of fenestrations.
